(19) United States
(12) Patent Application Publication
(10) Pub. No.: US 2016/0285386 A1
(43) Pub. Date: Sep. 29, 2016

(54) RECTIFIER

(71) Applicant: SHARP KABUSSHIKI KAISHA, Osaka-Shi, Osaka (JP)

(72) Inventors: KOHTAROH KATAOKA, Osaka (JP); SHUJI WAKAIKI, Osaka (JP); HIROKI IGARASHI, Osaka (JP); AKIHIDE SHIBATA, Osaka (JP); HIROSHI IWATA, Osaka (JP)

(21) Appl. No.: 15/032,337

(22) PCT Filed: Sep. 3, 2014
(86) PCT No.: PCT/JP2014/073132

§ 371 Date: Apr. 27, 2016

(30) Foreign Application Priority Data
Nov. 29, 2013 (JP) 2013-247756

(51) Int. Cl. H02M 7/217; H02M 7/06

(52) U.S. Cl. CPC H02M 7/217; H02M 7/06

(57) ABSTRACT

A switching circuit (10) is used as a high-side rectifying unit of a boost chopper. The switching circuit (10) includes a low-breakdown voltage transistor (11), a high-breakdown voltage transistor (13) having a drain connected to a drain of the low-breakdown voltage transistor (11), and a diode (high-speed flyback diode) (15) having a cathode connected to a source of the low-breakdown voltage transistor (11) and an anode connected to a source of the high-breakdown voltage transistor (13). Before the generation of a flyback current by the turning off of a low-side transistor (22), the low-breakdown voltage transistor (11) is turned on while the high-breakdown voltage transistor (13) is kept off. After that, the low-side transistor (22) is turned off.

### TECHNICAL FIELD

The present invention relates to a rectifier.

### BACKGROUND ART

Such a circuit as that shown in FIG. 25 has been proposed (see PTL 1). In FIG. 25, a series circuit of a high-breakdown voltage main element 901 to which a diode 902A is connected in antiparallel and a low-breakdown voltage backflow prevention element 903 including a built-in diode 902B is disposed between nodes 906 and 907, and a high-speed flyback diode 904 is connected between the nodes 906 and 907 with its anode disposed on the side of the node 907. In the circuit of FIG. 25, the main element 901 and the backflow prevention element 903 are turned on and off at the same time in synchronization with each other. A reduction in loss is achieved by passing a flyback current (rectified current) through the high-speed flyback diode 904, which is excellent in reverse recovery characteristic.

### CITATION LIST

### Patent Literature

PTL 1: Japanese Unexamined Patent Application Publication No. 2013-115933

### SUMMARY OF INVENTION

### Technical Problem

In the circuit of FIG. 25, a high voltage that causes the node 906 to have a positive voltage is applied between the node 906 and the node 907 before the start of flyback by the diode 904. At this point in time, the elements 901 and 903 are both in an off state, and as a result, the built-in diode 902B causes a node M interposed between the elements 901 and 903 to be at substantially the same potential as the node 906. Since the elements 901 and 903 are in an off state, lowering the potential of the node 906 with respect to the node 907 brings the node M into a floating state, and the potential of the node M is determined by the capacitances between conductive electrodes (collector-emitter capacitances, source-drain capacitances) of the elements 901 and 903. In a case where the capacitance between the conductive electrodes of the high-breakdown voltage element 901 is not negligible in comparison with that of the element 903, the potential of the node M does not sufficiently drop even when the potential of the node 906 lowers, and as a result, the potential of the node M may exceed the breakdown voltage of the element 903 to break down the element 903.

It is therefore an object of the present invention to provide a rectifier that contributes to the avoidance of damage to a transistor.

### Solution to Problem

A rectifier according to the present invention includes: a switch circuit having first and second transistors, a rectifier diode, a first node, a second node, and a third node, the first and second transistors each having first and second conductive electrodes and a control electrode for bringing the first and second conductive electrodes into or out of conduction with each other, the rectifier diode having a cathode and an anode, the first conductive electrode of the first transistor and the cathode of the rectifier diode being connected to the first node, the second conductive electrodes of the first and second transistors being connected to the second node, the first conductive electrode of the second transistor and the anode of the rectifier diode being connected to the third node; a connecting circuit that intermittently supplies a rectified current to the switch circuit in a forward direction of the rectifier diode; and a control circuit that causes the first and second transistors to be on and off, respectively, when the rectified current starts to flow through the rectifier diode.

### Advantageous Effects of Invention

The present invention makes it possible to provide a rectifier that contributes to the avoidance of damage to a transistor.

### BRIEF DESCRIPTION OF DRAWINGS

FIG. 1 is a circuit diagram of a switch circuit according to a first embodiment of the present invention.

FIG. 2 is a set of diagrams (a) to (c) showing states, respectively, of the switch circuit according to the first embodiment of the present invention.

FIG. 3 is a circuit diagram of a switch circuit according to a second embodiment of the present invention.

FIG. 4 is a circuit diagram of a boost chopper according to the second embodiment of the present invention.

FIG. 5 is a diagram showing the transition from one state to another of the boost chopper according to the second embodiment of the present invention.

FIG. 6 is a diagram showing the transition from one state to another of a boost chopper according to a first reference technology.

FIG. 7 is a circuit diagram of a simulation used for the first reference technology.

FIG. 8 is a diagram showing a result of the simulation performed on the first reference technology.

FIG. 9 is a diagram showing the transition from one state to another of a boost chopper according to a second reference technology.

FIG. 10 is a circuit diagram of a simulation used for the second reference technology.

FIG. 11 is a set of diagrams (a) and (b) showing results of the simulation performed on the second reference technology.

FIG. 12 is a set of diagrams (a) and (b) showing results of a simulation of a technology of the second embodiment of the present invention.

FIG. 13 is a diagram for explaining the way in which synchronous rectification is performed in a boost chopper according to a third embodiment of the present invention.

FIG. 14 is a diagram showing a part of the transition from one state to another of the boost chopper according to the third embodiment of the present invention.

FIG. 15 is a diagram for explaining a change in node potential during the state transition.

FIG. 16 is a diagram for explaining a change in node potential during the state transition in the case of employment of a high-breakdown-voltage-first-off method of the third embodiment of the present invention.

FIG. 17 is a circuit diagram of a boost chopper according to a fourth embodiment of the present invention.

FIG. 18 is a set of diagrams (a) and (b) for explaining an operation of the boost chopper according to the fourth embodiment of the present invention.

FIG. 19 is a circuit diagram including a detailed circuit example of a charging circuit according to the boost chopper of the fourth embodiment of the present invention.

FIG. 20 is a circuit diagram including a detailed circuit example of a voltage source in the charging circuit according to the boost chopper of the fourth embodiment of the present invention.

FIG. 21 is a circuit diagram of an AC load drive circuit according to a fifth embodiment of the present invention.

FIG. 22 is a circuit diagram of a switching power supply device according to a sixth embodiment of the present invention.

FIG. 23 is a state transition diagram of each switch and each charging circuit in a boost chopper mode according to the sixth embodiment of the present invention.

FIG. 24 is a circuit diagram of an insulating DC/DC converter according to a seventh embodiment of the present invention.

FIG. 25 is a diagram of a conventional circuit having a rectifying function.

### DESCRIPTION OF EMBODIMENTS

The following specifically describes examples of embodiments of the present invention with reference to the drawings. In each of the drawings that are referred to, identical components are given identical signs, and a repeated description of identical components is in principle omitted. It should be noted that, for simplification of explanation, information, a signal, a physical quantity, a quantity of state, a member, or the like is herein given a symbol or a sign referring thereto, whereby the name of the information, the signal, the physical quantity, the quantity of state, the member, or the like corresponding to the symbol or the sign may be omitted or abbreviated.

### First Embodiment

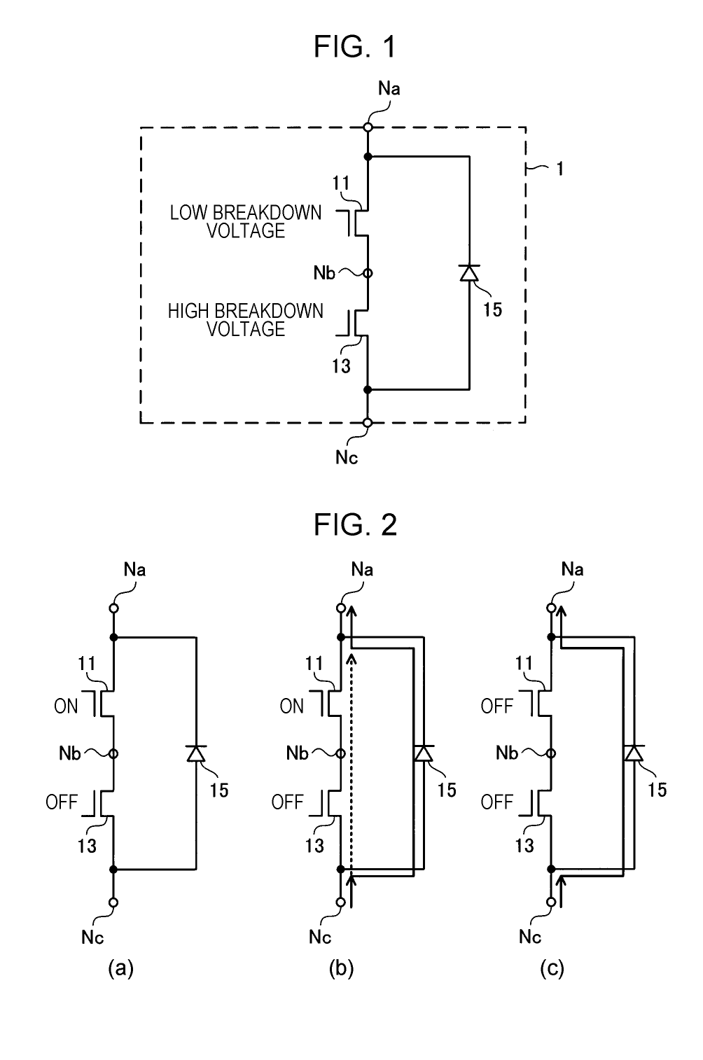

A first embodiment of the present invention is described. FIG. 1 is a circuit diagram of a switch circuit 1 according to the present invention. The switch circuit may be called a rectifier circuit. The switch circuit 1 includes a switching element 11 (hereinafter referred to as “low-breakdown voltage transistor 11” or “transistor 11”) formed as a FET (field-effect transistor), a switching element 13 (hereinafter referred to as “high-breakdown voltage transistor 13” or “transistor 13”) formed as a FET having a higher breakdown voltage than the low-breakdown voltage transistor 11, and a diode (rectifier diode, high-speed flyback diode) 15 that is formed by a fast recovery diode or the like. The transistors 11 and 13 ae N-channel FETs. In the switch circuit 1, a source of the transistor 11 and a cathode of the diode 15 are commonly connected at a node Na, a source of the transistor 13 and an anode of the diode 15 are commonly connected at a node Nc, and drains of the transistors 11 and 13 are commonly connected at a node Nb.

FIG. 2(a) shows a state of the switch circuit 1 prior to generation of a rectified current from the node Nc to the node Na. FIG. 2(b) shows a state of the switch circuit 1 during the generation of the rectified current. FIG. 2(c) shows a state of the switch circuit 1 immediately prior to stoppage of the rectified current. As shown in FIG. 2(a), in the switch circuit 1, the low-breakdown voltage transistor 11 is kept on and the high-breakdown voltage transistor 13 is kept off before the rectified current is generated. At this point in time, a higher voltage is applied to the node Na than to the node Nc, and meanwhile, a potential of the node Nb is equal to a potential of the node Na, as the low-breakdown voltage transistor 11 is on. After that, when the potential of the node Na becomes lower than the potential of the node Nc beyond a forward drop voltage (Vf) of the diode 15, the rectified current flows from the node Nc to the node Na as shown in FIG. 2(b) (In a case where the high-breakdown voltage transistor 13 includes a built-in diode, the rectified current also flows through a path that passes through the built-in diode and the low-breakdown voltage transistor 11). During the transition from the state of FIG. 2(a) to the state of FIG. 2(b), the source and drain of the low-breakdown voltage transistor 11 become substantially equal in potential, as the low-breakdown voltage transistor 11 is on. Therefore, the low-breakdown voltage transistor 11 is not broken down.

Furthermore, after that, it is preferable that the low-breakdown voltage transistor 11 be turned off as shown in FIG. 2(c) before the rectified current from the node Nc to the node Na stops. Accordingly, in a case where the high-breakdown voltage transistor 13 includes a built-in diode, the rectified current of the built-in diode stops, and the rectified current flows through only the diode 15. Therefore, provided a fast recovery diode or the like is used as the diode 15, a good reverse recovery characteristic is achieved at the time of stoppage of the rectified current. This makes it possible to suppress a loss or noise of a circuit including the switch circuit 1.

As the low-breakdown voltage transistor 11, a transistor whose drain-source breakdown voltage is 10 to 100 V (volts) can be used, for example. Use of a MOSFET made of silicon makes it possible to inexpensively form the transistor 11. Use as the low-breakdown voltage transistor 11 of a transistor having a lower drain-source breakdown voltage than the high-breakdown voltage transistor makes it possible to reduce the conduction resistance and chip area of the low-breakdown voltage transistor 11.

It is only necessary to select, as the high-breakdown voltage transistor 13, a transistor whose breakdown voltage corresponds to a voltage that is handled by the circuit. For example, when an input or output voltage to or from the circuit is 300 V, it is possible to select, as the high-breakdown voltage transistor 13, a transistor having a source-drain breakdown voltage of 600 V. A MOSFET made of silicon may be used as the high-breakdown voltage transistor 13. In particular, a SJ-MOSFET (superjunction MOSFET) may be used in high-breakdown voltage and large-current applications. Besides these transistors, a SiC-MOSFET (silicon carbide MOSFET) may be used as the high-breakdown voltage transistor 13.

In the switch circuit 1, the transistor 11 is turned on before the start of flyback, i.e., in a state where a higher voltage is applied to the node Na than to the node Nc. For this reason, the transistor 13 must have such withstand voltage performance as to be able to withstand the high voltage alone, while the transistor 11 does not need to withstand such a high voltage. Therefore, the transistor 11 is configured to be lower in breakdown voltage than the transistor 13. Lowering the breakdown voltage of the transistor 11 leads to a cost reduction, and use of a MOSFET as the transistor 11 leads to a reduction in on resistance. In a case where the transistor 13 is formed by a MOSFET, a drift layer (which, in the case of an n-type MOSFET, is an n-type impurity layer) in which a depletion layer is formed is thickened and an impurity concentration is thinned, as it is necessary to ensure a high breakdown voltage. This leads to an increase in on resistance.

In a case where a FET is used as the high-breakdown voltage transistor 13, it is possible to perform such rectification (i.e., synchronous rectification) as to pass a rectified current through channels of the high-breakdown voltage transistor 13 and the low-breakdown voltage transistor 11, not the diode 15, for example, by turning on the high-breakdown voltage transistor 13 in an interval between a period of the state of FIG. 2(b) and a period of the state of FIG. 2(c). Note here that the interval between a period of the state of FIG. 2(b) and a period of the state of FIG. 2(c) refers to a period of time between a point in time following the start of flow of the rectified current through the diode 15 and a point in time preceding the stoppage of the rectified current. Performing such an operation enables a low-loss operation free of a loss due to a diode voltage drop.

Further, the switch circuit 1 not only enables rectification in a direction from the node Nc toward the node Na, but also makes it possible to pass an electric current from the node Na to the node Nc, provided the transistors 11 and 13 are turned on. Therefore, for example, the switch circuit 1 can be used as a high-side or low-side arm (switch) of an inverter circuit. In this case, a bipolar transistor or an IGBT (insulated gate bipolar transistor), as well as a FET such as a MOSFET, can be used as the high-breakdown voltage transistor 13. In particular, use of a FET as the high-breakdown voltage transistor 13 makes it possible to suppress a conduction loss. In a case where an IGBT (n-channel IGBT in which an n-type channel is formed) or an NPN bipolar transistor is employed as the high-breakdown voltage transistor 13, an emitter of the IGBT or the bipolar transistor needs only be connected to the node Nc, and a collector or the IGBT or the bipolar transistor needs only be connected to the node Nb.

In a case where a fast recovery diode is used as the diode 15, it is possible, for example, to suppress a reverse recovery current (recovery current) that is generated in the diode 15 at the turning on of a switching element connected to the node Nc. This offers an advantage in increasing the efficiency of a switching operation. Note, however, that a diode other than a fast recovery diode is suitable as the diode 15, provided such a diode has a high breakdown voltage and a good reverse recovery characteristic (recovery characteristic). For example, the diode 15 may be formed by a high-breakdown voltage Schottky barrier diode made of silicon carbide or the like.

### Second Embodiment

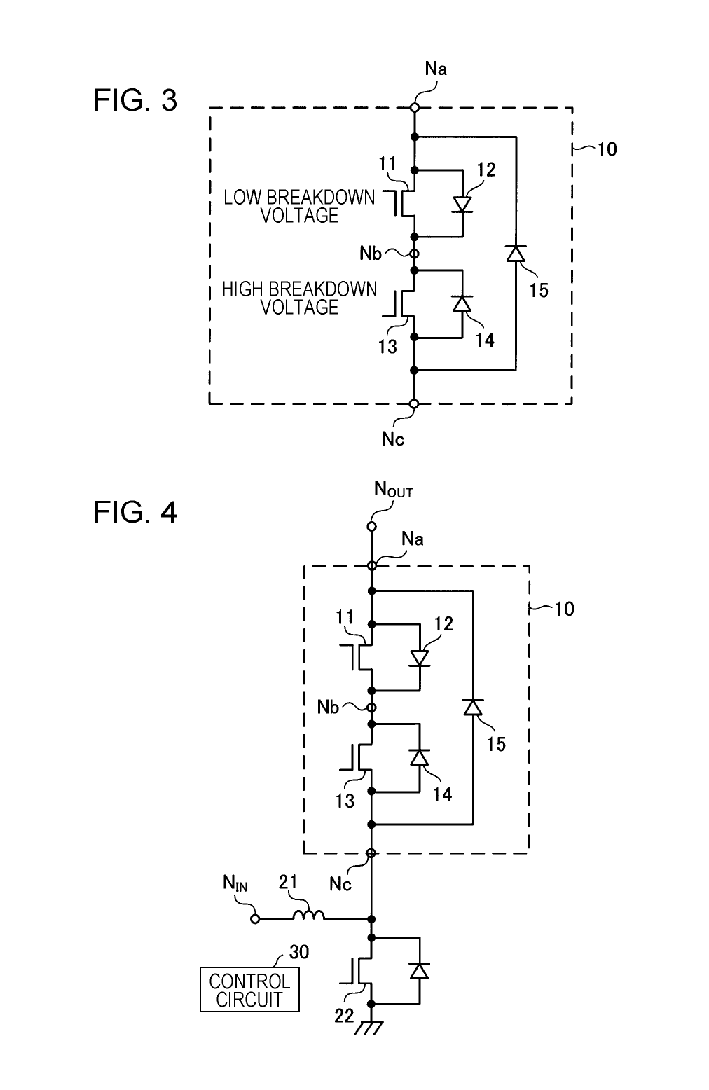

A second embodiment of the present invention is described. In each of the embodiments described below, a circuit including a switch circuit 10, which is an example of the switch circuit 1, is described. FIG. 3 is a circuit diagram of the switch circuit 10. In the switch circuit 10, N-channel MOSFETs are used as the high-breakdown voltage transistor 11 and the high-breakdown voltage 13. Therefore, a diode 12, whose forward direction is a direction from the source of the transistor 11 toward the drain of the transistor 11, is added in parallel to the transistor 11 as a built-in diode, and a diode 14, whose forward direction is a direction from the source of the transistor 13 toward the drain of the transistor 13, is added in parallel to the transistor 13 as a built-in transistor. As the diode 15 in the switch circuit 10, a diode with a good reverse recovery characteristic, such as a fast recovery diode, is used. The diode 15 is hereinafter also referred to as “FRD 15”.

FIG. 4 shows a circuit example in which the switch circuit 10 is used as a high-side switch circuit of a boost chopper. The boost chopper of FIG. 4 includes a switch circuit 10, a coil 21, a transistor 22 (hereinafter also referred to as “low-side transistor 22”), which is a low-side element, and a control circuit 30. In FIG. 4, the transistor 22 is formed by an N-channel MOSFET. In FIG. 4, a diode connected in parallel to the transistor 22 is a built-in diode of the transistor 22 as a MOSFET (The same applies to other drawings in which the transistor 22 is shown). In the boost chopper of FIG. 4, the coil 21 has a first end connected to an input node N_{IN} and a second end connected to a drain of the transistor 22 and connected to the node Nc of the switch circuit 10, the transistor 22 has its source connected to a ground having a reference potential of 0 V (volt), and the switch circuit 10 has its node Na connected to an output node N_{OUT}.

The boost chopper boosts a predetermined DC voltage that is applied to the input node N_{IN} and outputs, through the output node N_{OUT}, an output voltage obtained by the boosting. In the boost chopper of FIG. 4, the switch circuit 10 is used as a rectifying unit for use in output voltage generation. Connected to the output node N_{OUT} is a smoothing capacitor (not illustrated) for smoothing the output voltage.

The control circuit 30 achieves a boosting operation by controlling the turning on and turning off of each switching element including the transistors 11, 13, and 22. As might be expected, the turning on of a transistor formed by a MOSFET means that the drain and source of the MOSFET are brought into a conduction state, and the turning off of a transistor formed by a MOSFET means that the drain and source of the MOSFET are brought out of a conduction state. In the boosting operation, the control circuit 30 alternately turns on and off the low-side transistor 22 by using PWM (pulse width modulation) control. The transistor 22 functions as a switching element that switches the supply of an electric current to the coil 21. The turning on of the transistor 22 causes the coil 21 to accumulate energy, and then the turning off of the transistor 22 causes the accumulated energy of the coil 21 to be outputted to the node N_{OUT} through the switch circuit 10, whereby a boosted output voltage is obtained.

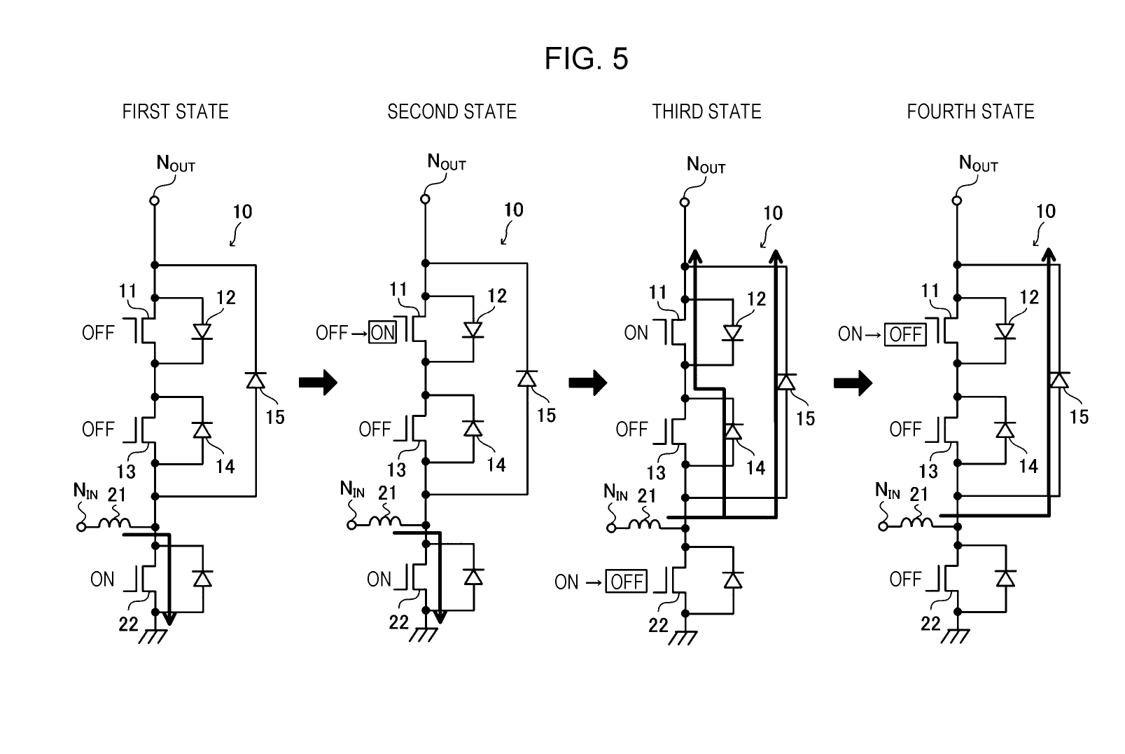

FIG. 5 shows the transition between on and off states of each switching element in the boosting operation. The control circuit 30 repeatedly executes a loop process in which the boost chopper changes from a first state to a second, a third, and a fourth state in sequence and returns to the first state.

In the first state, the transistors 11, 13, and 22 are off, off, and on, respectively. In the second state, the transistors 11, 13, and 22 are on, off, and on, respectively. In the third state, the transistors 11, 13, and 22 are on, off, and off, respectively. In the fourth state, the transistors 11, 13, and 22 are off, off, and off, respectively.

It should be noted that for the sake of brevity of drawings, the drawings (including FIG. 5) of the boost chopper for explaining the switching states and the like may omit to illustrate the control circuit 30.

In accordance with the main purport of the technology described in the first embodiment, the high-side low-breakdown voltage transistor 11 is turned on while the low-side transistor 22 is on. That is, with the first state as a starting point, the low-breakdown voltage transistor 11 is turned on before the low-side transistor 22 is turned off. After that, the low-side transistor 22 is turned off, whereby the boost chopper reaches the third state. At this point in time, a rectified current from the coil 21 (i.e., a flyback current based on the accumulated energy of the coil 21) flows to the output node N_{OUT} via the path that passes through the built-in diode 14 of the high-breakdown voltage transistor 13 and the channel (i.e., source-drain) of the low-breakdown voltage transistor 11 and a path that passes through the FRD 15. During the transition from the second state to the third state, the source and drain of the low-breakdown voltage transistor 11 become substantially equal in potential, as the low-breakdown voltage transistor 11 is on. Therefore, the low-breakdown voltage transistor 11 is not broken down. Moreover, it is preferable that the low-breakdown voltage transistor 11 be kept off (fourth state) before the low-side transistor 22 is turned on again. This causes the rectified current from the coil 21 to flow through only the FRD 15. After that, the low-side transistor 22 is turned on, whereby the boost chopper returns to the first state.

After entry into the third state and before entry into the fourth state, the turning on of the high-breakdown voltage transistor 13 enables synchronous rectification, and the synchronous rectification enables a low-loss operation free of a loss due to a diode voltage drop. Note, however, that it is not always necessary to perform synchronous rectification. For example, it is possible to perform synchronous rectification only at the time of a large current and not to perform synchronous rectification at the time of a small current.

First Reference Technology

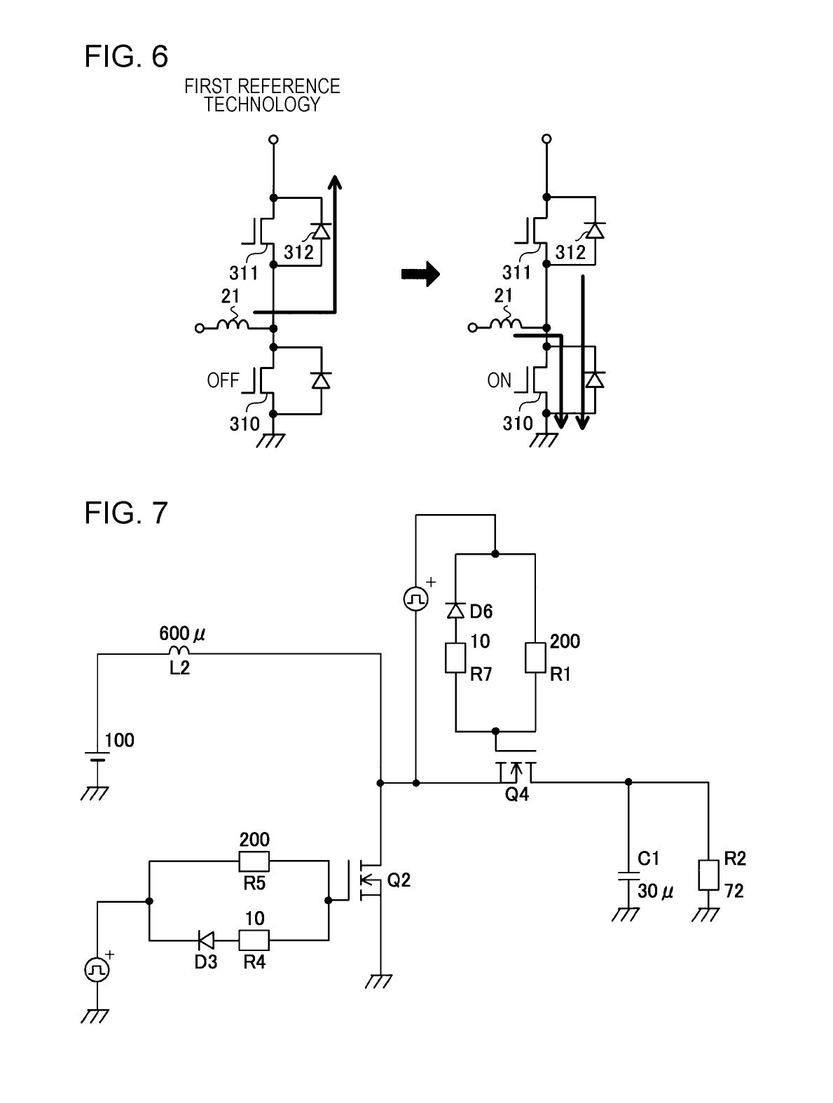

The following describes the benefits of the configuration and operation of the boost chopper shown in FIGS. 4 and 5. First, a boost chopper whose high side is formed by a single MOSFET 311 is discussed as a first reference technology with reference to FIG. 6. In the boost chopper of FIG. 6, too, a low-side transistor 310 is alternately turned on and off. In FIG. 6, when the transistor 310 is off, an electric current flows through a built-in diode 312 of the MOSFET 311, and in this case, a small number of carriers are accumulated in a depletion layer of the built-in diode 312. When the transistor 310 is turned on, the accumulated carriers are released as a reverse recovery current from the built-in diode 312. However, since the reverse recovery characteristic of the built-in diode 312 of the single MOSFET 311 is basically not good, the reverse recovery current causes a great switching loss of the transistor 310. In particular, in a high-breakdown voltage and low-resistance MOSFET such as a SJ-MOSFET, the source-drain capacitance is very high when the source-drain voltage is low, and charge and discharge currents for this capacitance, as well as the electric current of the coil 21 and the reverse recovery current of the built-in diode 312, flow through the transistor 310 at the turning on of the transistor 310; therefore, a very large peak current is generated to cause a great switching loss.

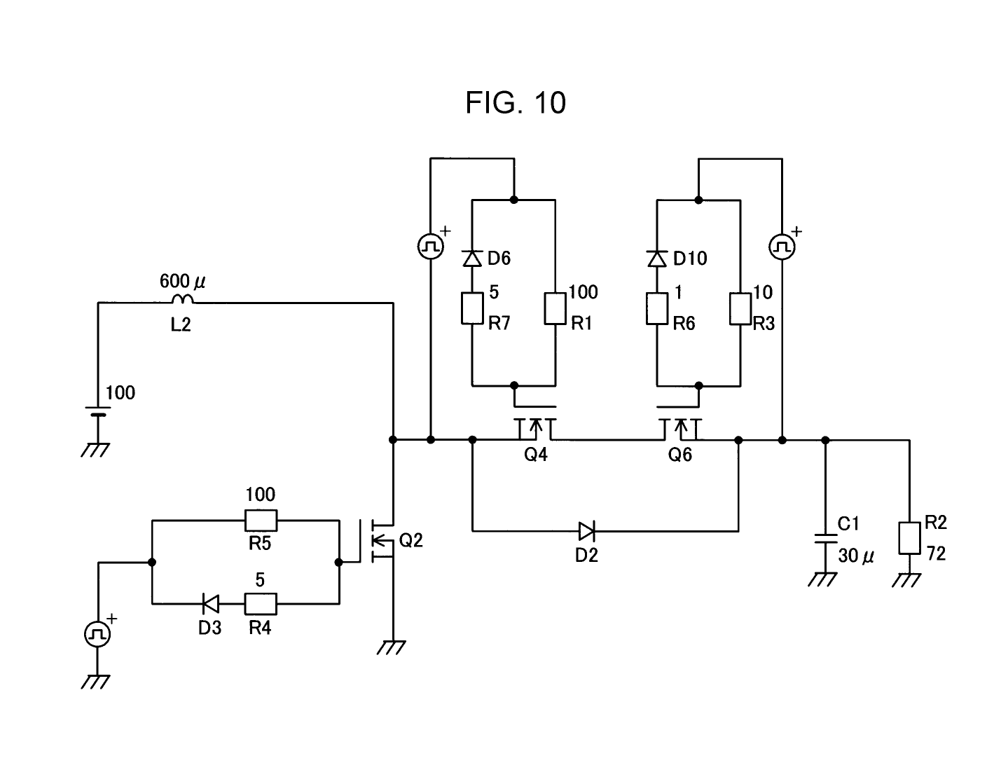

A first simulation was performed on the boost chopper of the first reference technology by a SPICE model. FIG. 7 shows a circuit of a simulation used for the first reference technology. In FIG. 7 and FIG. 10, which will be described below, the inductance and capacitance of a coil Li and a capacitor Ci are shown in the vicinity thereof, and a diode Di is an ideal Schottky barrier diode (excluding the diode D2 of FIG. 10; i is an integer). As a model of each of the MOSFETs Q2 and Q4, “IPW65R037C6_L0” was used. In the first simulation, the low-side MOSFET Q2 is switched with 75% on duty at a frequency of 20 kHz, whereby an output voltage of 384 V is obtained from an input voltage of 100 V (The same applies to the after-mentioned second and third simulations). A signal complementary to a gate signal to the low-side MOSFET Q2 is inputted to a gate of the MOSFET Q2 with a dead time of 3 microseconds (hereinafter denoted by “μs”), whereby synchronous rectification is performed.

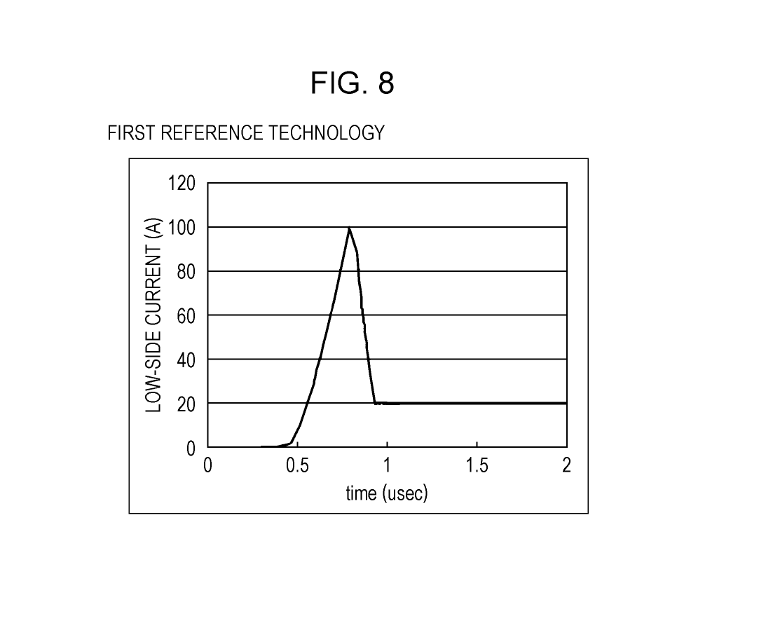

FIG. 8 shows a waveform of a low-side current (electric current that flows through Q2) at the turning on of the MOSFET Q2 in the first simulation. As shown in FIG. 8, a reverse recovery current from the high side is added to an electric current (approximately 20 A) of the coil L2, whereby an electric current whose peak is approximately 100 A is generated. The reverse recovery time is considerably long (approximately 0.5 μs), which causes a great switching loss.

### —Second Reference Technology—

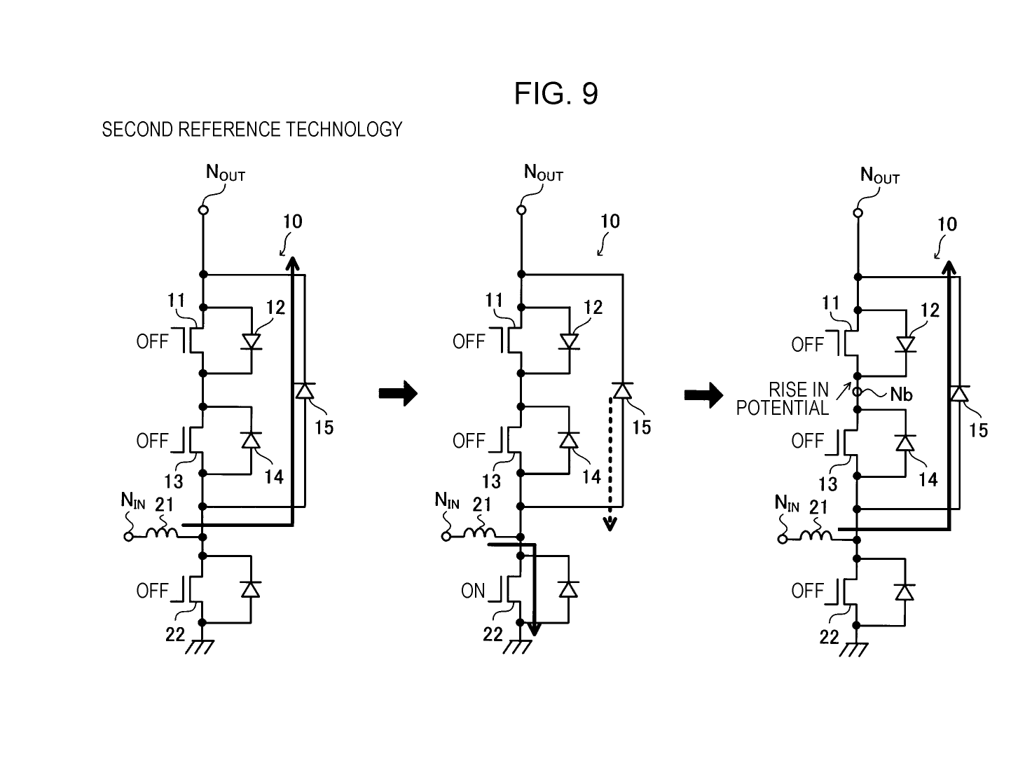

Next, a second reference technology is described with reference to FIG. 9. A boost chopper according to the second reference technology has the same circuit configuration as the boost chopper of FIG. 4. Note, however, that in the second reference technology, the high-side low-breakdown voltage transistor 11 and the high-side high-breakdown voltage transistor 13 are turned on and off at the same time. In the circuit of FIG. 9, during rectification, the low-breakdown voltage transistor 11 prevents an electric current from flowing through the built-in diode 14 of the high-breakdown voltage transistor 13, and rectification is performed by the FRD 15 with an excellent reverse recovery characteristic. Therefore, the reverse recovery current at the turning on of the low-side transistor 22 is smaller than it is in the first reference technology, and as a result, the switching loss is smaller.

However, when the low-side transistor 22 has been turned off, a rise in source potential of the high-side high-breakdown voltage transistor 13 causes a rise in potential of the floating drain (i.e., potential of the node Nb) via the source-drain capacitive coupling of the high-breakdown voltage transistor 13. Therefore, depending on the source-drain capacitance of the high-breakdown voltage transistor 13, the potential of the node Nb may rise beyond the breakdown voltage of the low-breakdown voltage transistor 11 to break down the low-breakdown voltage transistor 11.

A second simulation was performed on the boost chopper of the second reference technology by a SPICE model. FIG. 10 shows a circuit of a simulation used for the second reference technology. As a model of the MOSFET Q2, “IPW65R037C6_L0” was used. As models of the MOSFETs Q4 and Q6, which correspond to the high-breakdown voltage transistor 13 and the low-breakdown voltage transistor 11, “IPW65R037C6_L0” and “BSZ023N04LS_L0” were used, respectively. As a model of the diode D2, which corresponds to the FRD 15, “HFA45HC60C” was used. A signal complementary to a gate signal to the low-side MOSFET Q2 is inputted to gates of the MOSFETs Q4 and Q6 with a dead time of 3 μs, whereby synchronous rectification is performed.

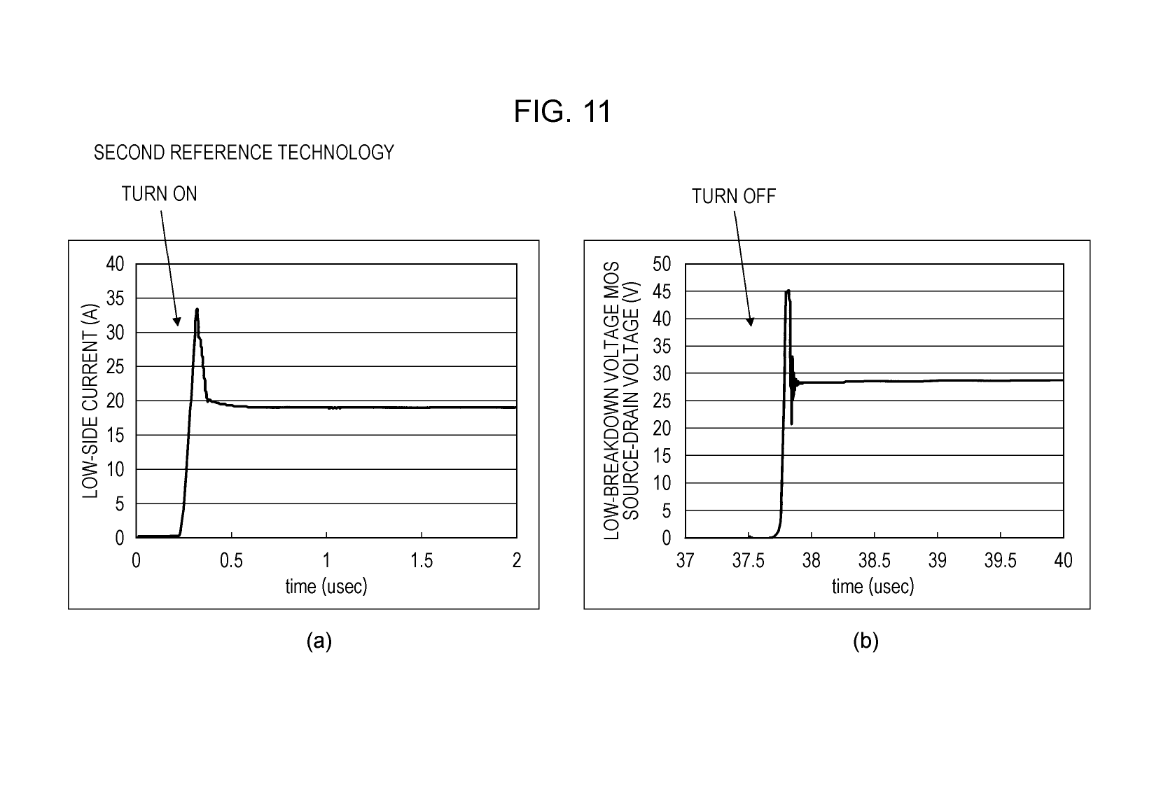

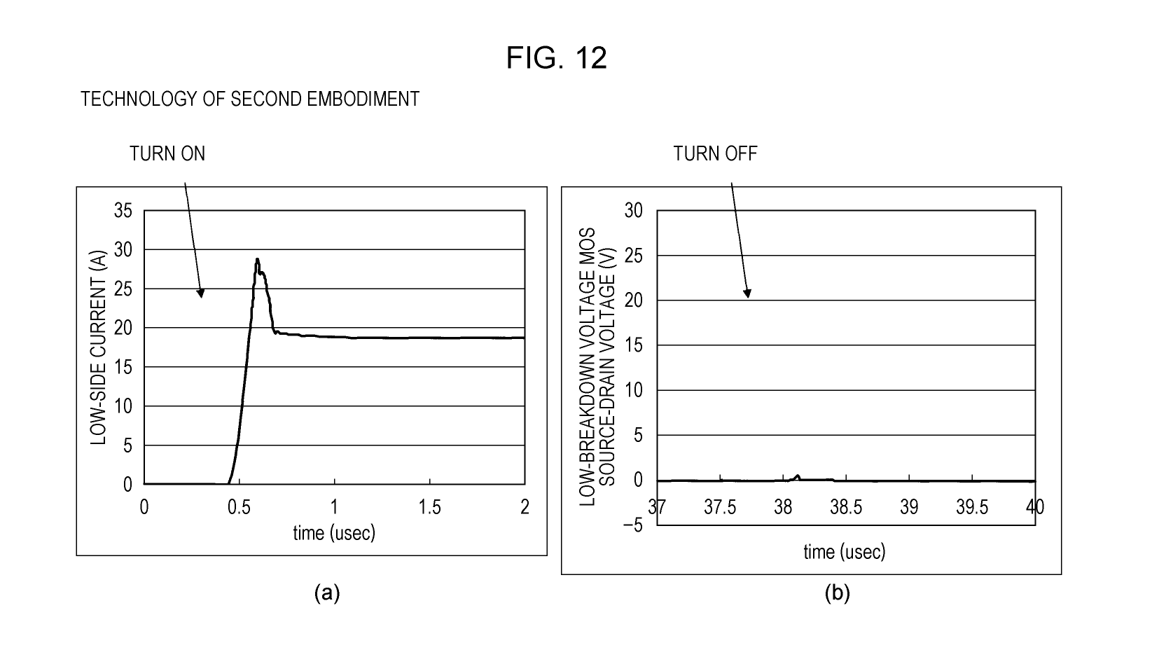

FIG. 11(a) shows a waveform of a low-side current (electric current that flows through Q2) at the turning on of the MOSFET Q2 in the second simulation. The flow of a rectified current (flyback current) through the diode D2, which corresponds to the FRD 15, shows that the reverse recovery characteristic is better than it is in the first reference technology (see FIG. 8). Meanwhile, at the turning off of the MOSFET Q2, the FET Q6 may be damaged, as a large voltage shown in FIG. 11(b) is applied between the source and drain of the low-breakdown voltage MOSFET Q6.

### —Technology of the Present Embodiment—

Therefore, in the boost chopper according to the present embodiment, the high-side low-breakdown voltage MOSFET is kept on before the start of high-side rectification. At the start of high-side rectification, i.e., at the turning off of the low-side transistor 22, a load of the drain node of the high-breakdown voltage transistor 13 flows to the source of the low-breakdown voltage transistor 11 to prevent a rise in potential, provided the low-breakdown voltage transistor 11 is kept on (see FIG. 5). Therefore, damage to the low-breakdown voltage transistor 11 is avoided.

To ascertain this effect, a third simulation was performed by using a circuit equivalent to the simulation circuit of FIG. 10 (Note, however, the resistance value of each resistor in the simulation circuit is slightly different from that of the second simulation, although such a difference is not essential). In the third simulation, unlike in the second simulation, the following switching is performed at timings of 0 μs to 50 μs constituting a period with a cycle of 20 kHz: At the timing of 0 μs, the low-side MOSFET Q2 is turned on while the high-side MOSFETs Q4 and Q6 are kept off (that is, the boost chopper changes from the fourth state to the first state; see FIG. 5).

At the timing of 3 μs, the high-side low-breakdown voltage MOSFET Q6 is turned on (that is, the boost chopper changes from the first state to the second state; see FIG. 5).

At the timing of 37.5 μs, the low-side MOSFET Q2 is turned off (that is, the boost chopper changes from the second state to the third state; see FIG. 5).

At the timing of 40.5 μs, the high-side high-breakdown voltage MOSFET Q4 is turned on, whereby synchronous rectification is started. The period of 37.5 to 40.5 μs corresponds to a dead time.

At the timing of 47 μs, the high-side MOSFETs Q4 and Q6 are both turned off (which brings the boost chopper into the fourth state; see FIG. 5).

FIG. 12(a) shows a waveform of a low-side current (electric current that flows through Q2) at the turning on of the MOSFET Q2 in the third simulation. As in the second reference technology (second simulation), it is shown that the reverse recovery characteristic is better than it is in the first reference technology (see FIG. 8). FIG. 12(b) shows a waveform of a voltage that is applied between the source and drain of the low-breakdown voltage MOSFET Q6 at the turning off of the MOSFET Q2 in the third simulation. In comparison with FIG. 11(b), FIG. 12(b) shows that the voltage is sufficiently kept down.

Thus, in the present embodiment, the low-breakdown voltage transistor 11 is turned on before the flyback current based on the accumulated energy of the coil 21 starts to flow through the FRD 15, and the low-breakdown voltage transistor 11 is kept on and the high-breakdown voltage transistor 13 is kept off at a point in time where the flyback current starts to flow and by the point in time (see FIG. 5). With this, application of an excess voltage between the source and drain of the low-breakdown voltage transistor and damage to the low-breakdown voltage transistor thereby, such as those which occur in the second reference technology, are avoided. Further, it is preferable that the transistors 11 and 13 be both kept off at a point in time of stoppage of supply of the flyback current to the switch circuit 10 and the FRD 15 and by the point in time (FIG. 5; before the transition from the fourth state to the first state). This causes the flyback current to flow through the FRD 15 immediately before the stoppage of flyback without flowing through the built-in diode 14 of the high-breakdown voltage MOSFET 13, thus giving a good reverse recovery characteristic to suppress a loss due to the reverse recovery current. It should be noted that the term “flyback current” may be read as “rectified current”.

### Third Embodiment

A third embodiment of the present invention is described. A third embodiment of the present invention is described. The third embodiment and the after-mentioned fourth to seventh embodiments are embodiments based on the first and second embodiments, and regarding matters that are not particularly stated in the third to seventh embodiments, the description of the first and second embodiments is applied to the third to seventh embodiments, unless there is any special mention or contradiction.

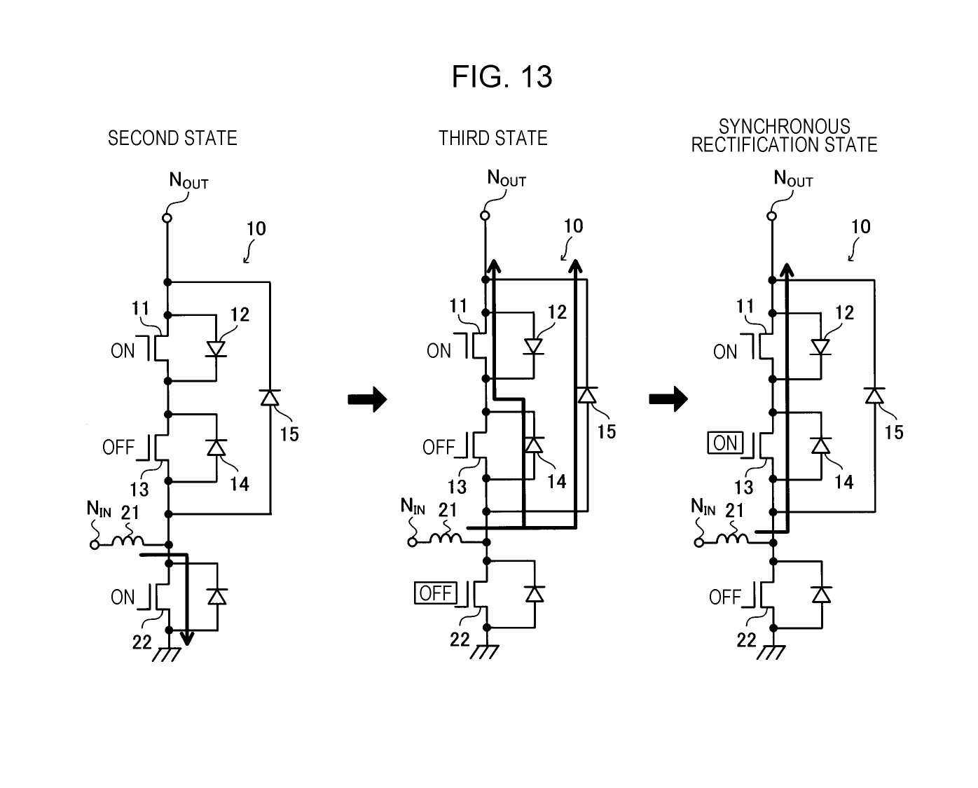

In the third embodiment, too, a boost chopper having the configuration of FIG. 4 is discussed. Further, for the sake of convenience, the periods during which the boost chopper is in the first to fourth states of FIG. 5 are called first to fourth periods, respectively. As mentioned in the second embodiment, synchronous rectification may be performed in the boost chopper of FIG. 4. That is, in the boosting operation of the boost chopper, a synchronous rectification period during which the boost chopper is in a synchronous rectification state may be provided between the third period and the fourth period (see FIG. 13). In the synchronous rectification state, the transistors 11, 13, and 22 are on, on, and off, respectively.

As mentioned above, when the turning off of the low-side transistor 22 causes the transition from the second state to the third state (see FIG. 5 or 13), the flyback current based on the accumulated energy of the coil 21 flows through the high-side switch circuit 10, and this flyback current flows to the output node NOUT via the path that passes through the built-in diode 14 of the high-breakdown voltage transistor 13 and the channel (i.e., source-drain) of the low-breakdown voltage transistor 11 and the path that passes through the FRD 15. Since both paths pass through a diode, there occurs a loss due to a diode forward voltage drop. Therefore, after the third period and before the fourth period, the control circuit 30 achieves synchronous rectification by turning on the high-breakdown voltage transistor 13. This causes the flyback current (rectified current) to pass through the channels of the low-resistance transistors 13 and 11 as shown in FIG. 13, thus making it possible to suppress a loss without generating a diode forward voltage drop. After that, tuning off both the transistors 11 and 13 immediately before turning of the low-side transistor 22 again causes the flyback current to flow through the FRD 15. This makes it possible, as in the second embodiment, to suppress a loss at the turning on of the low-side transistor 22. The following presupposes that synchronous rectification is performed in the boost chopper.

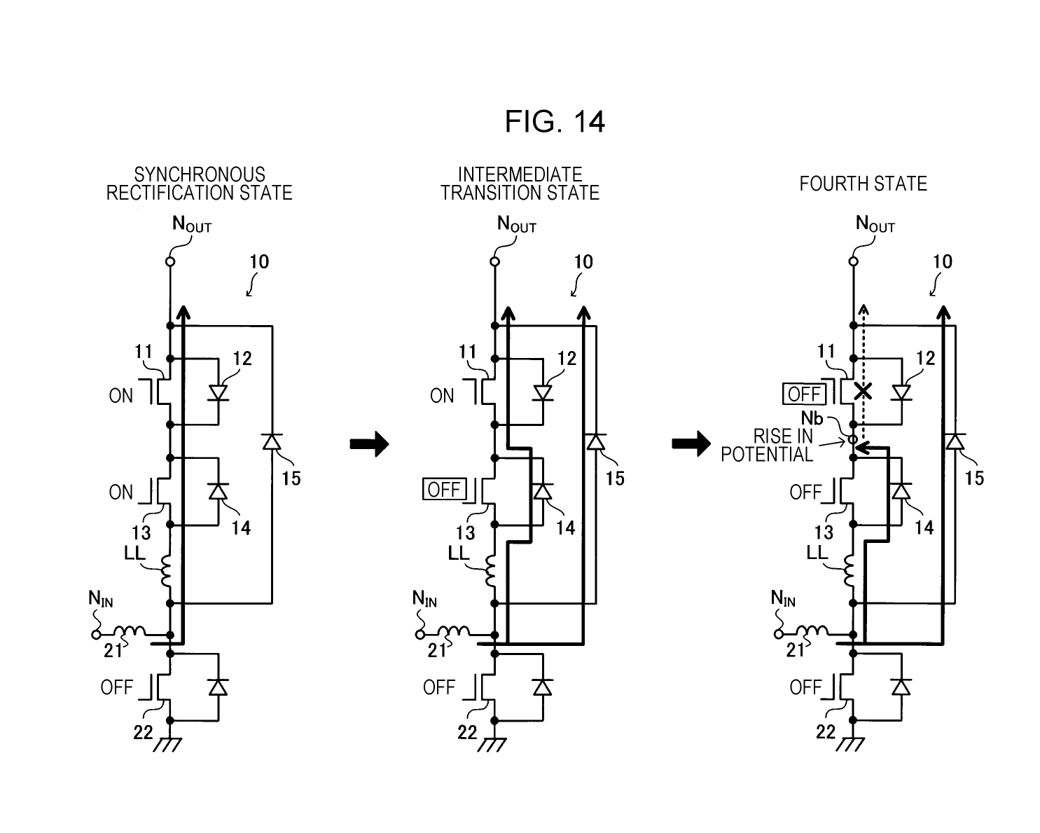

Furthermore, in ending synchronous rectification, the second embodiment employs a method (hereinafter referred to as “high-breakdown-voltage-first-off method”) in which the high-breakdown voltage transistor 13 of the rectifying unit (here, high-side) is turned off first and then the low-breakdown voltage transistor 11 is turned off. In the high-breakdown-voltage-first-off method, as shown in FIG. 14, an intermediate transition period during which the boost chopper is in an intermediate transition state is provided between the synchronous rectification period and the fourth period. In the intermediate transition state, the transistors 11, 13, and 22 are on, off, and off, respectively.

The high-breakdown-voltage-first-off method is described in detail. In switching from the synchronous rectification state to the fourth state, the high-breakdown voltage transistor 13 is turned off first. At this point in time, an electric current having passed through the low-breakdown voltage transistor 11 flows, as an electric current can pass through the built-in diode 14, although the channel of the high-breakdown voltage transistor 13 is turned off. It should be noted that the generation of a voltage drop in the built-in diode 14 causes a part of the flyback current to flow through the FRD 15 in the intermediate transition state as shown in FIG. 14.

Next, the low-breakdown voltage transistor 11 is turned off, too, whereby the boost chopper reaches the fourth state. This blocks the current path that passes through the transistors 13 and 11, with the result that the flyback current flows through only the FRD 15. Incidentally, a parasitic inductance component is always present in a wire that connects one element to another (In FIG. 14, LL represents a parasitic inductance component that is present in a wire between the source of the high-breakdown voltage transistor 13 and the drain of the low-side transistor 22). Therefore, when the current is interrupted by turning off the low-breakdown voltage transistor 11, a surge current due to the parasitic inductance component as caused by the interruption is supplied to the drain of the low-breakdown voltage transistor 11. Since the high-breakdown voltage transistor 13 is off, this surge current flows via the built-in diode 14 of the high-breakdown voltage transistor 13, and therefore, charge generated by the surge current is confined to the node Nb between the transistors 11 and 13 and cannot return in the reverse direction. That is, a part of the charge of the surge current due to the parasitic inductance component is confined to the node Nb, and in the fourth state, the potential of the node Nb becomes higher than the potential of the node Nc of the source of the high-breakdown voltage transistor 13 (see FIG. 14).

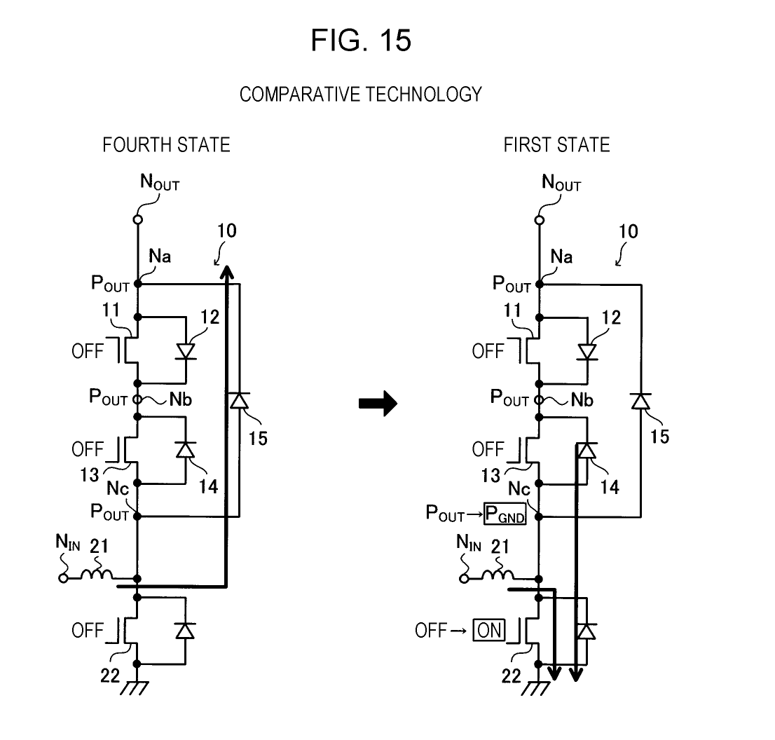

This advantage is explained by describing a comparative technology for turning off the transistors 11 and 13 at the same time or turning off the low-breakdown voltage transistor 11 first in turning off synchronous rectification. Reference is made to FIG. 15. The nodes Na to Nc of FIG. 15 are identical to those of FIG. 3. In the comparative technology, when the transistors 11 and 13 are turned off and the boost chopper thereby reaches the fourth state, in which the flyback current flows through only the FRD 15, the potentials of the nodes Na to Nc are substantially equal to the potential of the output node N_{OUT} (hereinafter referred to as “output node potential P_{OUT}), with the neglect of a diode voltage drop. That is, there is hardly a voltage difference between the source and drain of the high-breakdown voltage transistor 13. A smaller potential difference between the source and drain of a MOSFET means a higher source-drain capacitance at the turning off of the MOSFET. In particular, use of a high-breakdown voltage and low-resistance MOSFET such as a SJ-MOSFET as the high-breakdown voltage transistor 13 causes the capacitance to be very high when the potential difference between the source and the drain is small.

In the comparative technology, turning on the low-side transistor 22 from the fourth state causes the potential of the node Nc to drop to a potential P_{GND} of the ground (assuming that a voltage drop at the transistor 22 is zero). Meanwhile, the potential of the node Nb is maintained at the output node potential P_{OUT} by the built-in diode 12 of the low-breakdown voltage transistor 11. As a result, a voltage equivalent to the output node potential P_{OUT} is applied between the source and drain of the high-breakdown voltage transistor 13, whereby a charge current for the source-drain capacitance of the high-breakdown voltage transistor 13 is generated. This charge current is overlapped with a coil current at the turning on of the transistor 22 and flows through the transistor 22, thus becoming a factor for an increase in switching loss.

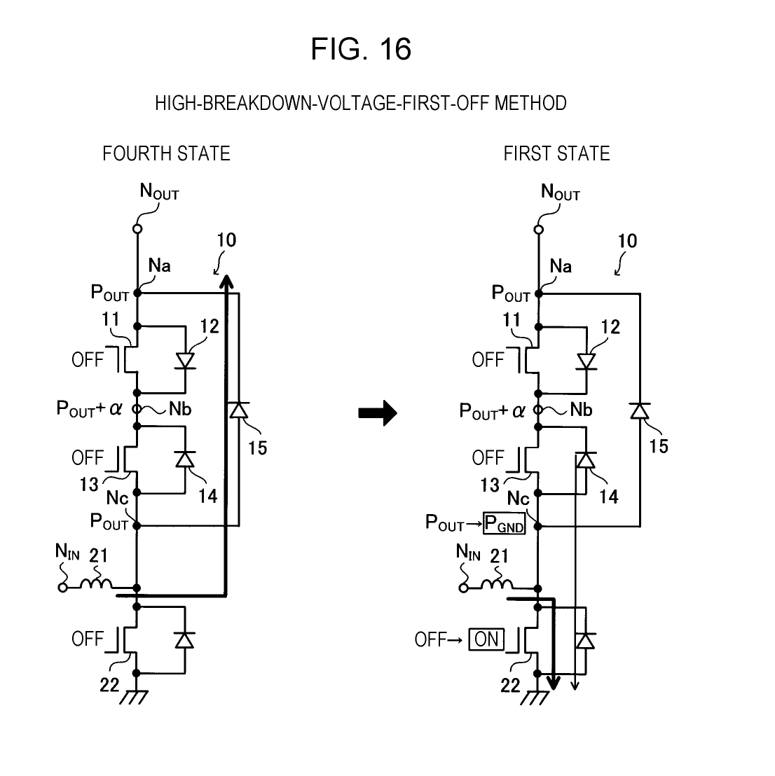

Next, behavior in a case where the high-breakdown voltage transistor 13 is turned off first in turning off synchronous rectification is described with reference to FIG. 16. In this case, when the low-breakdown voltage transistor 11 is turned off after the turning off of the high-breakdown voltage transistor 13 and the boost chopper reaches the fourth state, the charge generated by the surge current is confined to the node Nb, whereby the potential of the node Nb becomes a potential (P_{OUT}+α) that is higher than the output node potential P_{OUT}. That is, at the stage of the fourth state, a potential difference a has been generated between the source and drain of the high-breakdown voltage transistor 13. As mentioned above, the source-drain capacitance is very high when the potential difference between the source and the drain is small and decreases as the potential difference increases. Therefore, in the high-breakdown-voltage-first-off method, charging at a low potential difference with a high capacitance has been completed at the stage of the fourth state.

After that, when the low-side transistor 22 is turned on, an output node voltage is substantially applied between the source and drain of the high-breakdown voltage transistor 13. Therefore, as in the comparative technology, a charge current for the source-drain capacitance does flow. However, the charging at the turning on of the transistor 22 is charging from a state in which the potential difference a was generated, and the charging at a low potential difference with a high capacitance has already been completed at the stage of the fourth state. Therefore, the charge current is much smaller than it is in the comparative technology. This in turn allows a reduction in switching loss.

In the fourth state, the surge current that causes the potential of the node Nb to rise to the potential (P_{OUT}+α) is a surge current generated by an inductance component J that is present in a path of passage of an electric current toward the drain of the low-breakdown voltage transistor 11 in the synchronous rectification state and the intermediate transition state. The inductance component J can be any parasitic inductance component (including the parasitic inductance component LL of FIG. 14) that is present in the path of passage. A parasitic inductance component may be actively formed by routing a part of a wire long.

Alternatively, the inductance component J may be one generated by a coil element provided in series to the path of passage (e.g., the source or drain of the high-breakdown voltage transistor 13). The coil element may have an inductance value of, for example, several nH (nanohenry) to 100 nH.

### Fourth Embodiment

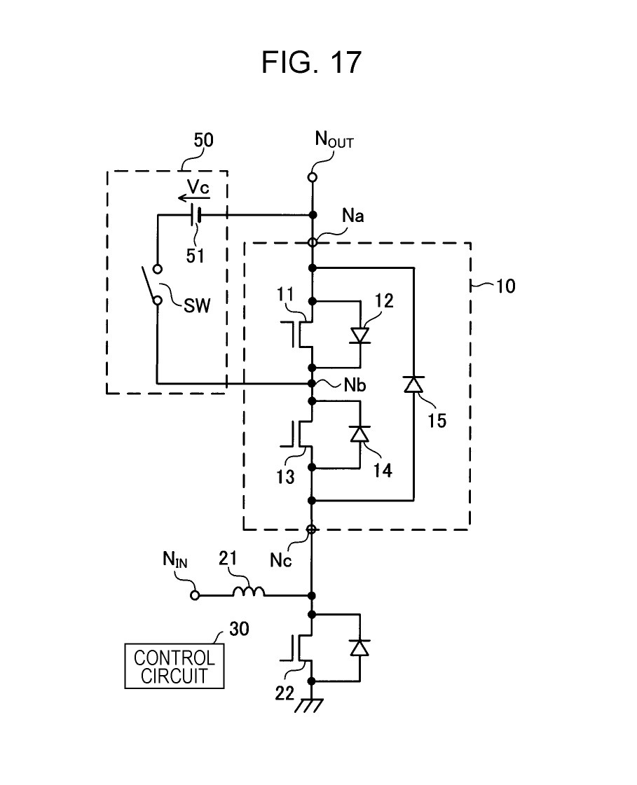

A fourth embodiment of the present invention is described. FIG. 17 is a circuit configuration diagram of a boost chopper according to the fourth embodiment. The boost chopper of FIG. 17 is one obtained by adding a charging circuit 50 to the boost chopper of FIG. 4. The charging circuit 50 includes a voltage source 51 and a switch SW. The voltage source 51 outputs a predetermined voltage Vc. Note here that the voltage Vc is a positive voltage that is lower than the source-drain breakdown voltage of the low-breakdown voltage transistor 11. A series circuit of the voltage source 51 and the switch SW is connected between the nodes Na and Nb. When the switch SW is on, the output voltage Vc of the voltage source 51 is applied to the node Nb with reference to the potential of the node Na, and when the switch SW is off, such a voltage is not applied. The control circuit 30 controls the turning on and turning off of the switch SW. In the boost chopper of FIG. 17, as in the second embodiment, before the turning off of the low-side transistor 22, the low-breakdown voltage transistor 11 is turned on while the high-breakdown voltage transistor 13 is maintained off. That is, the boost chopper of FIG. 17 changes from the first state to the second and third states in sequence. The following describes an operation prior to the turning on of the low-side transistor 22.

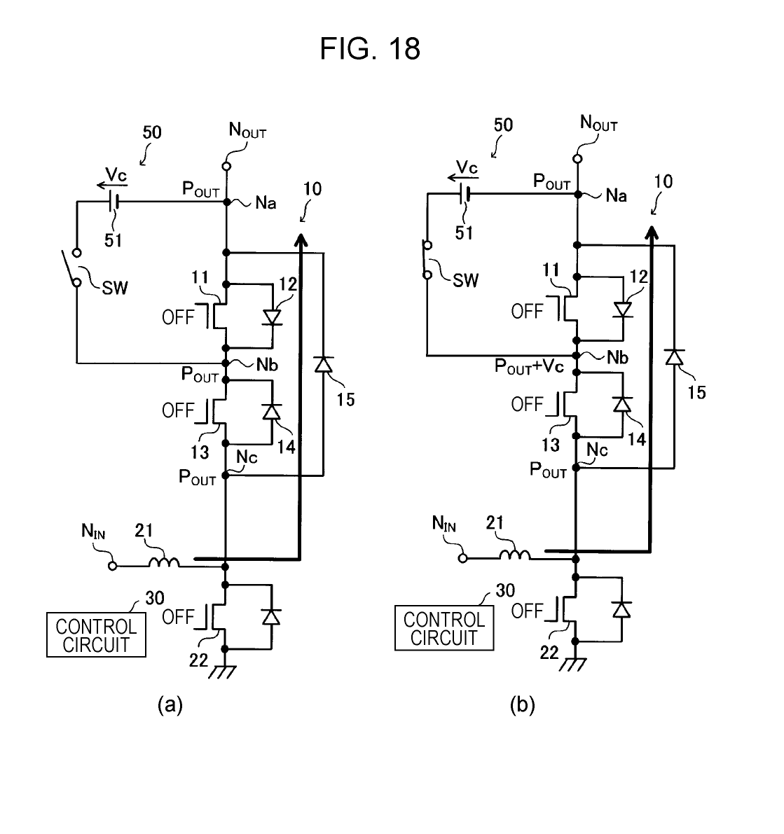

FIG. 18(a) shows an example of a state of the boost chopper of the fourth embodiment at a stage where the flyback current is flowing through the FRD 15. As in the third embodiment, when the flyback current is flowing through the switch circuit 10 (i.e., when the transistor 22 is off), synchronous rectification may be performed by turning on the transistors 11 and 13. In any case, the transistors 11 and 13 are both turned off immediately before the turning on of the low-side transistor 22. However, unlike in the aforementioned high-breakdown-voltage-first-off method, the order in which the transistors 11 and 13 are turned off is not questioned.

In the fourth state (see FIG. 5), where the transistors 11 and 13 are off and the flyback current is flowing through the FRD 15, the control circuit 30 keeps the switch SW on for a predetermined period of time as shown in FIG. 18(b), thereby applying the voltage Vc to the node Nb with reference to the node Na. After that, the low-side transistor 22 is turned on, and the switch SW is turned off by the time when the supply of the flyback current to the switch circuit 10 (FRD 15) stops. In a state other than the fourth state, the switch SW is maintained off.

With this, before the turning on of the low-side transistor 22, the voltage Vc is applied between the drain and source of the high-breakdown voltage transistor 13, the charging at a low potential different with a high capacitance can be completed at the stage of the fourth state. As a result, as in the high-breakdown-voltage-first-off method, the charge current of the high-breakdown voltage transistor 13 at the turning on of the low-side transistor 22 can be lowered in comparison with the comparative technology of FIG. 15. This makes it possible to perform switching stably at a higher speed and achieve a highly-efficient circuit operation. That is, in the comparative technology of FIG. 15, the low-side transistor 22 must perform the high-capacity charging of the high-breakdown voltage transistor 13. Therefore, the switching takes time and the switching loss becomes great. On the other hand, in the fourth embodiment, the charging circuit 50 completes a part of the capacity charging of the high-breakdown voltage transistor 13 at the stage of the fourth state. This suppresses the charge current at the turning on of the low-side transistor 22, thus making it possible to perform switching with low loss and at a high speed.

Further, the fourth embodiment, which uses the charging circuit 50, which outputs the voltage Vc, makes it possible to perform charging more stably than the high-breakdown-voltage-first-off method of the third embodiment, which utilizes the parasitic inductance component and the like.

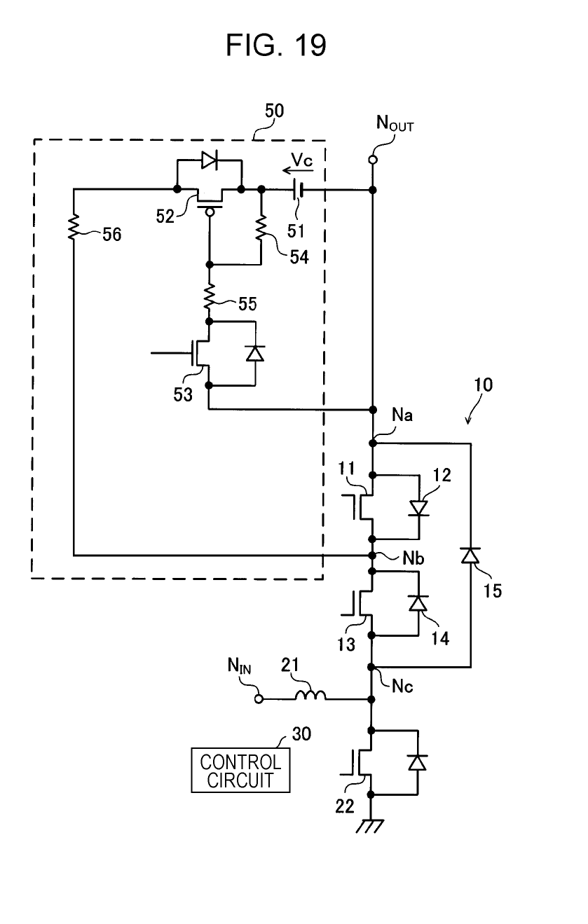

FIG. 19 is a circuit diagram of the boost chopper, including an example of an internal circuit diagram of the charging circuit 50. The charging circuit 50 of FIG. 19 includes components 51 to 56. The voltage source 51 has a negative output terminal connected to the node Na and a positive output terminal connected to a source of the transistor 52, which is a P-channel MOSFET, and connected to a gate of the transistor 52 via the resistor 54. The transistor 52 has its drain connected to the node Nb via the current-limiting resistor 56. Further, the transistor 52 has its gate connected to a drain of the transistor 53, which is an N-channel MOSFET, via the resistor 55, and has its source connected to the node Na. The resistor 56 is intended to stabilize an operation by limiting the magnitude of an electric current that is supplied from the voltage source 51 to the node Nb. The resistor 56 can be omitted.

The control circuit 30 controls the turning on and turning off of the transistor 52, which corresponds to the switch SW of FIG. 17, by controlling the turning on and turning off of the transistor 53. When the transistor 53 is off, the transistor 52 is off, too, as the presence of the resistor 54 makes the source and gate of the transistor 52 equal in potential. When the transistor 53 is on, the transistor 52 is on, too, as the gate potential of the transistor 52 is lowered via the resistor 55. When the transistor 52 is on, the potential of the node Nb is raised by the voltage source 51 with reference to the node Na. It should be noted that PNP and NPN bipolar transistors may be used as the transistors 52 and 53, respectively.

The output voltage Vc of the voltage source 51 is for example 10 to 60 V. For example, in a case where Vc=30 V, transistors whose drain-source breakdown voltage is approximately 40 to 60 V need only be selected as the transistors 52 and 53 and the low-breakdown voltage transistor 11. Further, the resistance values of the resistors 54 and 55 are set so that a voltage that is applied between the gate and source of the transistor 52 does not exceed the gate-source breakdown voltage of the transistor 52 and so that an excess current does not flow from the positive output terminal of the voltage source 51 to the negative output terminal of the voltage source 51 via the resistor 54, the resistor 55, and the transistor 53 when the transistor 53 is on. For example, in the case where Vc=30 V, setting each of the resistance values of the resistors 54 and 55 to 150Ω (ohm) causes a voltage of “−15 V” to be applied between the gate and source of the transistor 52 when the transistor 53 is on, thus causing an electric current of 100 mA to flow through the resistor 54. The transistor 53 needs only be on only for a period of time during which the node Nb is charged immediately before the turning on of the low-side transistor 22. For example, in a case where the switching frequency of the transistor 22 in PWM control is 20 kHz, setting the on-time of the transistor 53 per cycle to 2 μs makes it possible to keep down a loss in the resistors 54 and 55 during the on-time of the transistor 53 to 0.12 W (=30 V×100 mA×2/50).

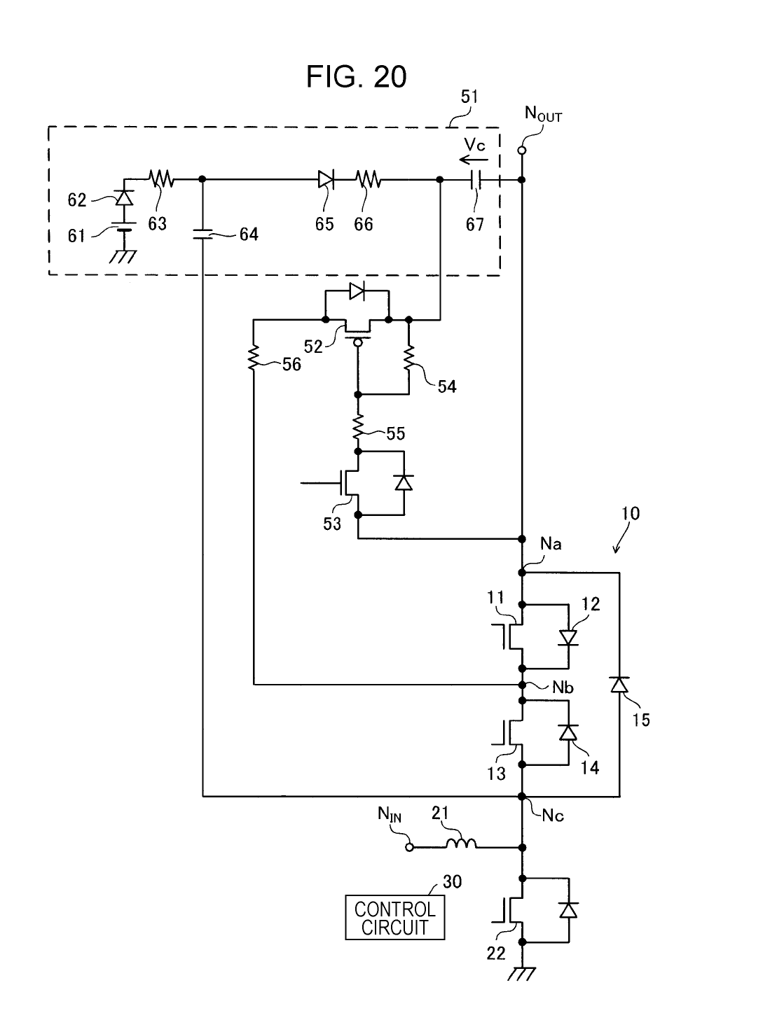

The voltage source 51 may be formed by an insulating regulator separately provided using a transformer. Alternatively, the voltage source 51 may be obtained by forming such a bootstrap circuit as that shown in FIG. 20. This eliminates the need for a separate transformer and, accordingly, makes it possible to form the voltage source 51 inexpensively. The voltage source 51 of FIG. 20 includes components 61 to 67. The voltage source 61 outputs a DC voltage based on the potential of the ground and has a positive output terminal connected to an anode of the diode 62. The diode 62 has its cathode connected to a first end of the capacitor 64 and an anode of the diode 65 via the current-limiting resistor 63. The capacitor 64 has a second end connected to the node Nc. The diode 65 has its cathode connected to a first end of the capacitor 67 and the source of the transistor 52 via the current-limiting resistor 66. The capacitor 67 has a second end connected to the node Na. With this, a voltage based on the ground from the voltage source 61 is level-shifted by utilizing an AC voltage of the node Nc, and the voltage Vc based on the node Na is generated in the capacitor 67.

### Fifth Embodiment

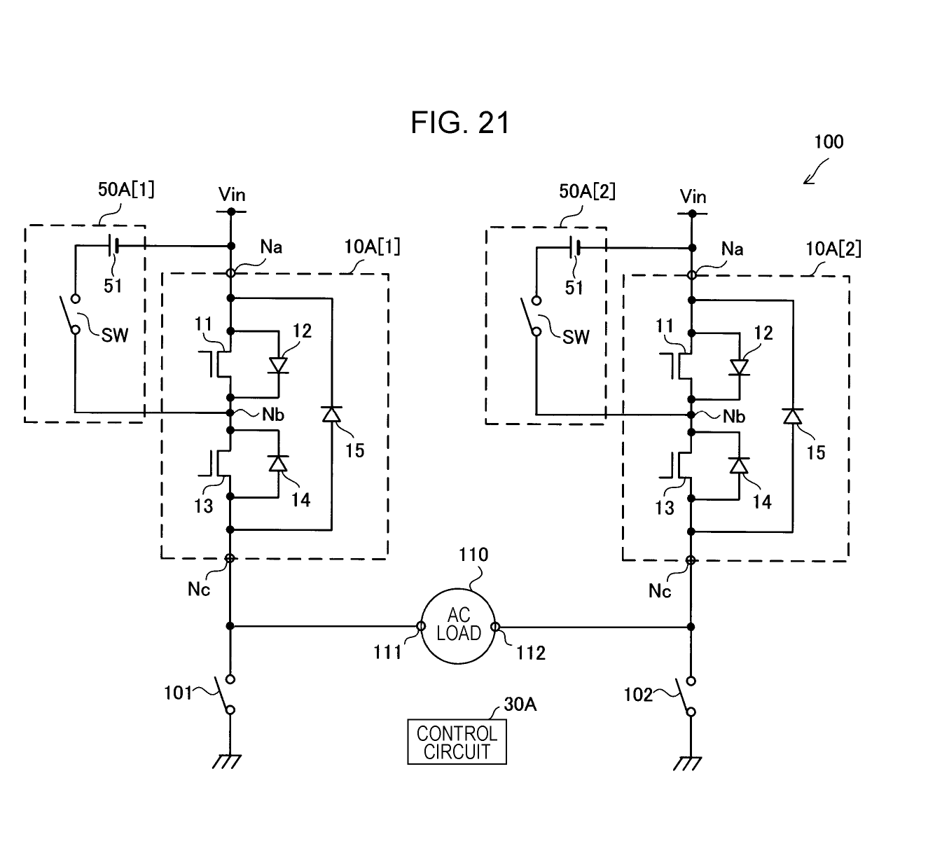

A fifth embodiment of the present invention is described. FIG. 21 is a circuit diagram of an AC load drive device 100 according to the fifth embodiment. The AC load drive device 100 includes a series circuit of a first high-side switch and a first low-side switch, a series circuit of a second high-side switch and a second low-side switch, and a control circuit 30A having the function of the aforementioned control circuit 30, with an AC load 110 connected between the two series circuits.

As at least either a combination of the first and second high-side switches or a combination of the first and second low-side switches, switch circuits 10 according to any one of the second to fourth embodiments (particularly preferably switch circuits 10 according to the fourth embodiment to which charging circuits 50 have been added, respectively) are used. In the example shown in FIG. 21, PWM switching (i.e., on-off switching based on PWM control) is performed only on the low-side switches. Therefore, a switch circuit 10A[1] to which a charging circuit 50A[1] has been added is used as the first high-side switch, and a switch circuit 10A[2] to which a charging circuit 50A[2] has been added is used as the second high-side switch. The charging circuit 50A[i] and the switch circuit 10A[i] are identical to the aforementioned charging circuit 50 and switch circuit 10, and the state of each of the circuits 50A[i] and 10A[i] is controlled by the control circuit 30A (i is an integer).

The reference signs 101 and 102 represent the first and second low-side switches, respectively. The control circuit 30A also controls the on/off state of each low-side switch. As each low-side switch, a high-breakdown voltage switching element may be used. For example, as each low-side switch (low-side switching element), an IGBT or a SJ-MOSFET may be used, or a FET made of SiC, GaN (gallium nitride), or the like may be used. Alternatively, each low-side switch may be formed by a plurality of transistors connected in parallel or in series.

In FIG. 21, a first inverter circuit is formed in the series circuit of the first high-side switch and the first low-side switch, and a second inverter circuit is formed in the series circuit of the second high-side switch and the second low-side switch, whereby a DC input voltage Vin is converted into an AC voltage by the first and second inverter circuits. As a specific configuration, the input voltage Vin is applied to the node Na of each of the switch circuits 10A[1] and 10A[2], the node Nc of the switch circuit 10A[1] is connected to a first end of the switch 101 and a power supply terminal 111 of the AC load 110, the node Nc of the switch circuit 10A[2] is connected to a first end of a switch 102 and a power supply terminal 112 of the AC load 110, and a second end of each of the switches 101 and 102 is connected to the ground. The AC load 110 is a given load that is driven by an AC voltage that is applied between the power supply terminals 111 and 112.

For example, in a first operation mode in which an electric current flows from the power supply terminal 111 to the power supply terminal 112, the first low-side switch 101 is maintained off and the high-breakdown voltage transistor 13 of the switch circuit 10A[1] is maintained on, whereby the second low-side switch 102 is switched on and off. The AC load 110 includes a coil equivalent to the coil 21 (see FIG. 5), and the switch 102 functions as a switch element that switches the supply of an electric current to the coil. When the switch 102 is off, the flyback current flows through the switch circuit 10A[2]. Therefore, in the first operation mode, an operation described in any one of the second to fourth embodiments is applied to the second high-side switch (10A[2], 50A[2]). This makes it possible to stably achieve highly-efficient switching with a switching loss kept down. In the first operation mode, the high-breakdown voltage transistor 13 of the switch circuit 10A[2] may be kept always off. However, as in the second to fourth embodiments, a loss corresponding to a diode voltage drop can be reduced by performing synchronous rectification in which the high-breakdown voltage transistor 13 of the switch circuit 10A[2] is turned on in synchronization with the turning off of the low-side switch 102. Further, in the first operation mode, the low-breakdown voltage transistor 11 of the switch circuit 10A[1] may be kept off. However, for the avoidance of generation of a loss corresponding to a voltage drop of the built-in diode 12, it is preferable that the low-breakdown voltage transistor 11 of the switch circuit 10A[1] be kept on.

In a second operation mode in which an electric current flows from the power supply terminal 112 to the power supply terminal 111, as opposed to the first operation mode, the first inverter circuit and the second inverter circuit may swap their operations with each other. In the circuit of FIG. 21, each high-breakdown voltage transistor 13 may be formed by an IGBT or a bipolar transistor. In particular, in high-voltage and large-current applications, costs can be kept lower than they are when a MOSFET is utilized. In this case, however, synchronous rectification is not performed.

### Sixth Embodiment

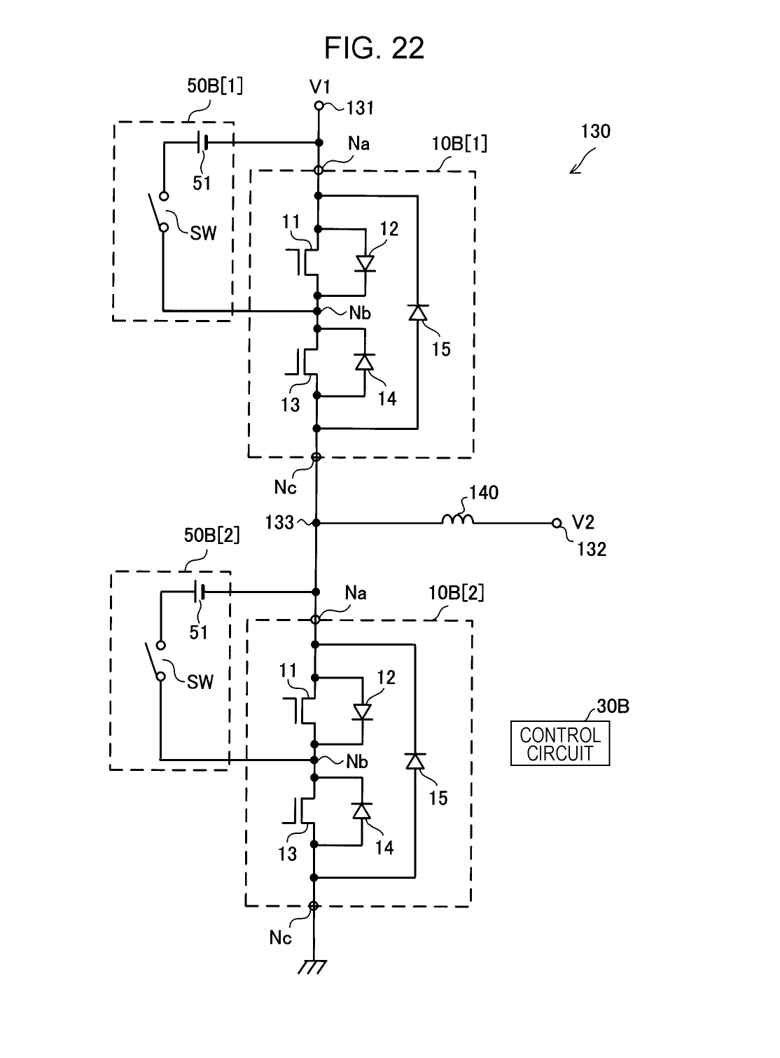

A sixth embodiment of the present invention is described. FIG. 22 is a circuit diagram of a switching power supply device 130 according to the sixth embodiment. The switching power supply device 130 includes a series circuit of a high-side switch and a low-side switch, two input-output terminals 131 and 132, a coil 140, and a control circuit 30B having the function of the aforementioned control circuit 30.

As the high-side switch and the low-side switch, switch circuits 10 according to any one of the second to fourth embodiments (particularly preferably switch circuits 10 according to the fourth embodiment to which charging circuits 50 have been added, respectively) are used. This makes it possible to highly efficiently and stably perform both an operation of passing the flyback current through the low-side switch by switching the high-side switch and an operation of passing the flyback current through the high-side switch by switching the low-side switch.

In the example shown in FIG. 22, a switch circuit 10B[1] to which a charging circuit 50B[1] has been added is used as the high-side switch, and a switch circuit 10B[2] to which a charging circuit 50B[2] has been added is used as the low-side switch. The charging circuit 50B[i] and the switch circuit 10B[i] are identical to the aforementioned charging circuit 50 and switch circuit 10, and the state of each of the circuits 50B[i] and 10B[i] is controlled by the control circuit 30B (i is an integer). Specifically, the node Na of the switch circuit 10B[1] is connected to the input-output terminal 131, the node Nc of the switch circuit 10B[1] and the node Na of the switch circuit 10B[2] are commonly connected at a node 133, the node Nc of the switch circuit 10B[2] is connected to the ground, and the coil 140 is connected between the node 133 and the input-output terminal 132. Voltages at the terminals 131 and 132 are denoted by V1 and V2, respectively (V1>V2). A smoothing capacitor (not illustrated) may be connected to each of the terminals 131 and 132.

The device 130 of FIG. 22 can be used as a bidirectional chopper. The control circuit 30B in the bidirectional chopper can operate in a step-down chopper mode in which the voltages V1 and V2 are an input voltage and an output voltage, respectively, or a boost chopper mode in which the voltages V1 and V2 are an output voltage and an input voltage, respectively.

In the step-down chopper mode, PWM switching (i.e., on-off switching based on PWM control) is performed on the high-breakdown voltage transistor 13 of the switch circuit 10B[1], as the high-breakdown voltage transistor 13 of the switch circuit 10B[1] functions as a switching element that switches the supply of an electric current to the coil 140. In the step-down chopper mode, an operation described in any one of the second to fourth embodiments needs only be applied to the low-side switch (10B[2], 50B[2]). That is, for example, the operation of the fourth embodiment needs only be applied with the assumption that the coil 140, the high-breakdown voltage transistor 13 of the switch circuit 10B[1], the switch circuit 10B[2], and the charging circuit 50B[2], which are shown in FIG. 22, are the coil 21, the transistor 22, the switch circuit 10, and the charging circuit 50, which are shown in FIG. 17. This makes it possible to reduce a switching loss during the turning on of the high-side switch (i.e., the turning on of the transistor 13 of the circuit 10B[1]). In the step-down chopper mode, the low-breakdown voltage transistor 11 of the switch circuit 10B[1] may be kept off. However, for the avoidance of generation of a loss corresponding to a voltage drop of the built-in diode 12, it is preferable that the low-breakdown voltage transistor 11 of the switch circuit 10B[1] be kept on. It should be noted that in the step-down chopper mode, the charging circuit 50B[1] may be kept deactivated (because it is not needed).

In the boost chopper mode, PWM switching (i.e., on-off switching based on PWM control) is performed on the high-breakdown voltage transistor 13 of the switch circuit 10B[2], as the high-breakdown voltage transistor 13 of the switch circuit 10B[2] functions as a switching element that switches the supply of an electric current to the coil 140. In the boost chopper mode, an operation described in any one of the second to fourth embodiments needs only be applied to the high-side switch (10B[1], 50B[1]). That is, for example, the operation of the fourth embodiment needs only be applied with the assumption that the coil 140, the high-breakdown voltage transistor 13 of the switch circuit 10B[2], the switch circuit 10B[1], and the charging circuit 50B[1], which are shown in FIG. 22, are the coil 21, the transistor 22, the switch circuit 10, and the charging circuit 50, which are shown in FIG. 17. This makes it possible to reduce a switching loss during the turning on of the low-side switch (i.e., the turning on of the transistor 13 of the circuit 10B[2]). In the boost chopper mode, the low-breakdown voltage transistor 11 of the switch circuit 10B[2] may be on or off. However, for the aforementioned reason, it is preferable that the low-breakdown voltage transistor 11 of the switch circuit 10B[2] be maintained on. It should be noted that in the boost chopper mode, the charging circuit 50B[2] may be kept deactivated (because it is not needed).

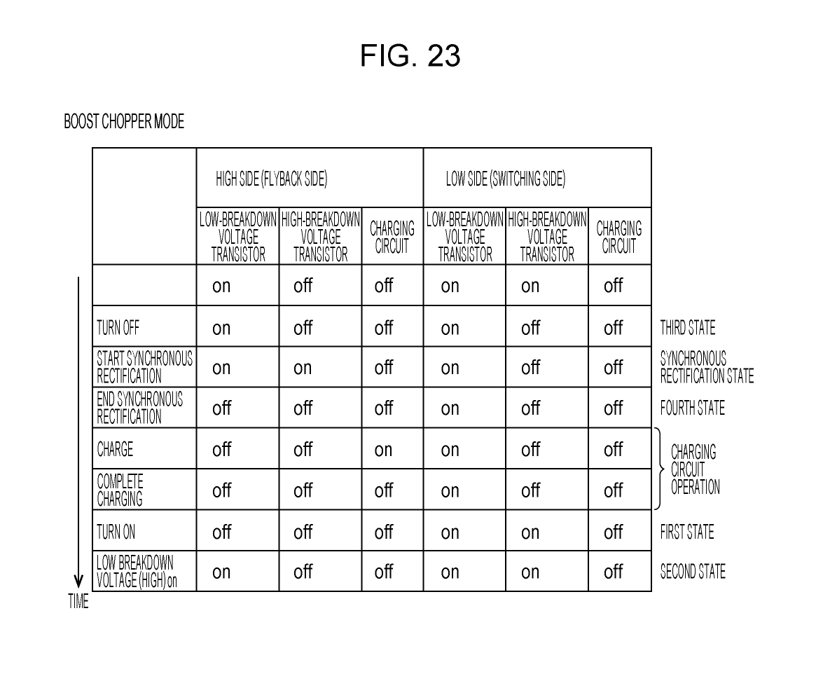

FIG. 23 is a state transition diagram of the low-breakdown voltage and high-breakdown voltage transistors and charging circuits of the high-side and low-side switches in the boost chopper mode (also see FIG. 5). In FIG. 23, the terms on and “off” are synonymous with on and “off”, respectively.

In the circuit of FIG. 22, too, use of a FET as each high-breakdown voltage transistor 13 makes it possible to suppress a conduction loss, and performing the aforementioned synchronous rectification makes it possible to suppress a loss corresponding to a diode voltage drop. In the circuit of FIG. 22, as in the fifth embodiment, each high-breakdown voltage transistor 13 may be formed by an IGBT or a bipolar transistor. In particular, in high-voltage and large-current applications, costs can be kept lower than they are when a MOSFET is utilized. In this case, however, synchronous rectification is not performed.

### Seventh Embodiment

A seventh embodiment of the present invention is described. A technology of any one of the second to fourth embodiments may be applied to a secondary-side rectifying unit of an insulating DC/DC converter (insulating direct current to direct current converter). FIG. 22 is a circuit diagram of an insulating DC/DC converter 200 to which the technology has been applied. In the example shown in FIG. 22, a push-pull circuit is constituted on a primary side, and a secondary-side circuit is constituted by a full bridge. Alternatively, anther transformation method may be employed.

The circuit configuration of FIG. 22 is described. The converter 200 includes a voltage source 201 that outputs a predetermined DC voltage, switches 202 and 203 formed as N-channel FETs, a transformer 204, switch circuits 10C[1] to 10C[4] that are identical in configuration to the switch circuit 10, charging circuits 50C[1] to 50C[4] that are identical in configuration to the charging circuit 50, and a control circuit 30C having the function of the aforementioned control circuit 30. The transformer 204 includes a winding wire 206 connected to the components 201 to 203 and a winding wire 207 connected to the switch circuits 10C[1] to 10C[4]. The winding wire 206 functions as a primary-side winding wire, and the winding wire 207 functions as a secondary-side winding wire (As will be described below, there is an exception). In the method described in the fourth embodiment, the charging circuit 50C[i] is connected to the switch circuit 10C[i] (i is an integer).

The voltage source 201 has a negative output terminal connected to a first end of the primary-side winding wire via the switch 202 and connected to a second end of the primary-side winding wire via the switch 203. The voltage source 201 has a positive output terminal connected to a center tap 205 provided in the center of the primary-side winding wire between the two ends. The secondary-side winding wire has a first end connected to a node 211 and a second end connected to a node 212. The node Nc of the switch circuit 10C[1] and the node Na of the switch circuit 10C[2] are commonly connected at the node 211, and the node Nc of the switch circuit 10C[3] and the node Na of the switch circuit 10C[4] are commonly connected at the node 212. The node Na of each of the switch circuits 10C[1] and 10C[3] is connected to an output terminal 210, and the node Nc of each of the switch circuits 10C[2] and 10C[4] is connected to a ground (secondary-side ground).

An AC voltage is generated between the two ends of the secondary-side winding wire by alternately turning on the switches 202 and 203. The AC voltage generated in the secondary-side winding wire is full-wave rectified by using the switch circuits 10C[1] to 10C[4], and a voltage obtained by the full-wave rectification is applied to the output terminal 210. A smoothing capacitor (not illustrated) is connected between the output terminal 210 and the ground (secondary-side ground).

The control circuit 30C can achieve synchronous rectification by turning on the high-breakdown voltage transistor 13 of the required switch circuit 10C[i] in accordance with a rectified current that is generated on the secondary side in synchronization with the on-off switching of the switches 202 and 203, thereby making it possible to reduce a loss due to a diode voltage drop.

In this embodiment, as in each of the embodiments described above, the low-breakdown voltage transistor 11 of the switch circuit 10C[i] is turned on before the rectified current (i.e., the electric current from the secondary-side winding wire) starts to flow through the FRD 15 of the switch circuit 10C[i], and the low-breakdown voltage transistor 11 and high-breakdown voltage transistor 13 of the switch circuit 10C[i] are kept on and off, respectively, at a point in time where the rectified current starts to flow. Then, in the switch circuit 10C[i], after the rectified current has started to flow, synchronous rectification is achieved by turning on the high-breakdown voltage transistor 13. After that, the transistors 11 and 13 are both turned off by a point in time where the supply of the rectified current to the switch circuit 10C[i] stops. In this case, in the switch circuit 10C[i], it is only necessary to cause the charging circuit 50C[i] to perform the operation described in the fourth embodiment after the transistors 11 and 13 have been turned off and before the supply of the rectified current to the switch circuit 10C[i] stops.

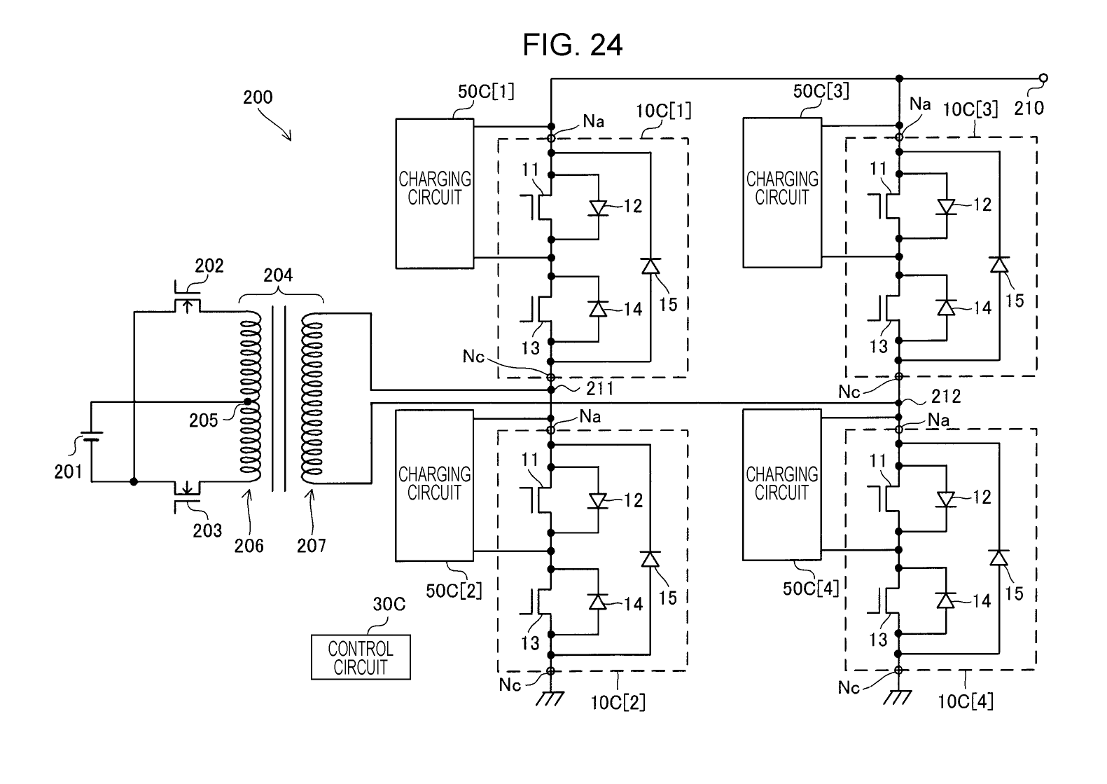

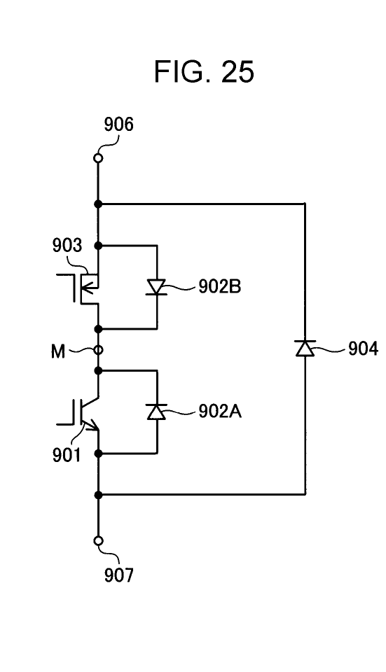

Further, the on-off switching of the primary-side switches (202, 203) suspends the rectified current on the secondary side and changes the direction of an electric current that flows through the secondary side, and the configuration of FIG. 24 makes it possible to reduce a reverse recovery current that is generated on the secondary side when the direction of the electric current is changed (thanks to the function of the FRD 15). The reverse recovery current generated on the secondary side may generate a surge on the primary side via the transformer 204. In particular, in a case where the secondary side is higher in voltage (i.e., higher in boost ratio) than the primary side, the surge caused by the reverse recovery current poses a risk of inviting disruptions in transformer current waveform to reduce the efficiency. In FIG. 24, such a risk is prevented.

Further, in FIG. 24, a circuit on the right side of the transformer 204, i.e., a circuit connected to the winding wire 207 is formed by a switching element. This allows the winding wire 207 to function as the primary side and allows the winding wire 206 to functions as the secondary-side winding wire. Therefore, the converter 200 can become a bidirectional converter. In this case, the transistors (202, 203) included in the secondary-side circuit connected to the winding wire 206 serve as rectifying elements. Therefore, a technology described in any one of the second to fourth embodiments may be applied as needed to the secondary-side circuit connected to the winding wire 206. That is, switching circuits 10 may be used as the transistors 202 and 203, respectively. In this case, the node Nc of each of the switch circuits 10 as the transistors 202 and 203 may be connected to the negative output terminal of the voltage source 201, and the nodes Na of the switch circuits 10 as the transistors 202 and 203 may be connected to the first and second ends, respectively, of the winding wire 206.

<<Modifications and the Like>>

Embodiments of the present invention may be varied in various ways as appropriate within the scope of technical ideas recited in the scope of claims. These embodiments are merely examples of embodiments of the present invention, and the meanings of the terms for the present invention and each component are not limited to those described in these embodiments. The specific numerical values shown in the foregoing description are mere examples and, of course, can be changed to various numerical values.

An additional description of the configuration of the low-breakdown voltage transistor 11 and the high-breakdown voltage transistor 13 is given, although such a description partially overlaps the contents hitherto described.

In each of the embodiments, an antiparallel diode may be connected to the low-breakdown voltage transistor 11 especially in the absence of the built-in diode 12, and an antiparallel diode may be connected to the high-breakdown voltage transistor 13 especially in the absence of the built-in diode 14. The anode and cathode of an antiparallel diode that can be connected to the low-breakdown voltage transistor 11 are connected to the node Na and the node Nb, respectively. The anode and cathode of an antiparallel diode that can be connected to the high-breakdown voltage transistor 13 are connected to the node Nc and the node Nb, respectively.

In each of the embodiments, a FET such as a MOSFET is used as the low-breakdown voltage transistor 11. The built-in diode 12 or an antiparallel diode may or may not be added to the low-breakdown voltage transistor 11.

In a unidirectional chopper (i.e., a boost chopper or a step-down chopper), a FET such as a MOSFET is used as the high-breakdown voltage transistor 13 to perform synchronous rectification.

In an inverter circuit or a bidirectional chopper (see FIGS. 21 and 22), too, a FET such as a MOSFET can be used as the high-breakdown voltage transistor 13 to bring about an effect of reducing a loss during conduction. Performing synchronous rectification gives higher efficiency. Note, however, that in an inverter circuit or a bidirectional chopper, an IGBT or a bipolar transistor can alternatively be used as the high-breakdown voltage transistor 13. In this case, however, synchronous rectification is impossible.

In either case, it is not essential to add the built-in diode 14 or an antiparallel diode to the high-breakdown voltage transistor 13. Note, however, that it is necessary to add the built-in diode 14 or an antiparallel diode to the high-breakdown voltage transistor 13 in utilizing the high-breakdown-voltage-first-off method of the third embodiment.

In an inverter circuit or a bidirectional chopper, when an electric current flows in a direction opposite to the direction of rectification (i.e., the forward direction of the FRD 15), the low-breakdown voltage transistor 11 and the high-breakdown voltage transistor 13 may be turned on in any order and turned off in any order. The low-breakdown voltage transistor 11 and the high-breakdown voltage transistor 13 may be turned on at the same time or turned off at the same time.

As for the FETs in each of the embodiments, a modification that replaces the N-channel FETs with P-channel FETs is possible, and vice versa. For example, the low-breakdown voltage transistor 11 and the high-breakdown voltage transistor 13 may be formed by P-channel FETs. In this case, the sources of the low-breakdown voltage transistor 11 and the high-breakdown voltage transistor 13 may be connected to each other at the node Nb, the drain of the low-breakdown voltage transistor 11 and the cathode of the FRD 15 may be connected at the node Na, and the drain of the high-breakdown voltage transistor 13 and the anode of the FRD 15 may be connected at the node Nc.

<<Discussion of the Present Invention>>

The contents of the present invention are discussed.

A rectifier according to an aspect of the present invention includes: a switch circuit (1, 10) having first and second transistors (11, 13), a rectifier diode (15), a first node (Na), a second node (Nb), and a third node (Nc), the first and second transistors (11, 13) each having first and second conductive electrodes and a control electrode for bringing the first and second conductive electrodes into or out of conduction with each other, the rectifier diode (15) having a cathode and an anode, the first conductive electrode of the first transistor and the cathode of the rectifier diode being connected to the first node (Na), the second conductive electrodes of the first and second transistors being connected to the second node (Nb), the first conductive electrode of the second transistor and the anode of the rectifier diode being connected to the third node (Nc); a connecting circuit that intermittently supplies a rectified current to the switch circuit in a forward direction of the rectifier diode; and a control circuit (30, 30A to 30B) that causes the first and second transistors to be on and off, respectively, when the rectified current starts to flow through the rectifier diode.

In the rectifier, the potential difference between the first and third nodes becomes lower when the rectified current flows through the rectifier diode. At this point in time, if the second node is in a floating state, the capacitive coupling between the conductive electrodes of the second transistor may cause the potential of the second node to rise beyond the breakdown voltage of the first transistor to damage the first transistor. As in the configuration, causing the first and second transistors to be on and off, respectively, when the rectified current starts to flow through the rectifier diode brings the first and second nodes into conduction with each other, thus avoiding damage to the first transistor with no excess voltage applied to the first transistor.

The rectifier is embodied in a circuit described in any one of the embodiments described above. For example, in FIG. 4 or 17, the connection circuit is a circuit that includes the coil 21 and the low-side transistor 22. In the circuit of FIG. 21, for example, the connection circuit for the switch circuit 10A[2] is a circuit that includes the switch circuit 10A[1], the AC load 110, and the switch 102. In the circuit of FIG. 22, for example, the connection circuit for the switch circuit 10B[2] is a circuit that includes the switch circuit 10B[1] and the coil 140, and the connection circuit for the switch circuit 10B[1] is a circuit that includes the switch circuit 10B[2] and the coil 140. In the circuit of FIG. 24, for example, the connection circuit for the switch circuit 10C[i] is a circuit that includes the components 201 to 204.

In a case where the ith transistor is a FET, one of the source and drain of the ith transistor is the first conductive electrode of the ith transistor, and the other of the source and drain of the ith transistor is the second conductive electrode of the ith transistor (i is an integer). In a case where the ith transistor is an IGBT or a bipolar transistor, one of the collector and emitter of the ith transistor is the first conductive electrode of the ith transistor, and the other of the collector and emitter of the ith transistor is the second conductive electrode of the ith transistor. The control electrode is the gate or base of the ith transistor.

In the controller, for example, the control circuit may cause the first and second transistors to be off when the supply of the rectified current to the switch circuit stops.

This causes the first and second transistors to be off when the supply of the rectified current to the switch circuit stops, thus allowing the rectified current immediately before the stoppage to flow through the rectifier diode, not a built-in diode of a transistor. Therefore, the formation of the rectifier diode by a diode with a good reverse recovery characteristic reduces a loss of a circuit including the rectifier.

In the rectifier, for example, the first and second transistors may be FETs, and the control circuit may pass the rectified current through the first and second transistors by causing the first and second transistors to be on in a part of a period from the start of flow of the rectified current through the rectifier diode to the stoppage of the supply of the rectified current to the switch circuit.

This achieves synchronous rectification to reduce a loss of a circuit including the rectifier.

Further, specifically, for example, the second transistor may have added thereto an additional diode (14) whose forward direction is a direction from the third node toward the second node, and after having turned on the first and second transistors in the part of the period, the control circuit may turn off the second transistor earlier than the first transistor in a process of turning off the first and second transistors.

An example of a circuit that embodies this technology is described in the third embodiment. At the stage where the second transistor has been turned off with the first transistor in an on state, the rectified current is still flowing to the first transistor via the additional diode of the second transistor. After this, blocking the path of passage of the rectified current via the first transistor by turning off the first transistor causes the rectified current to flow through only the path that passes through the rectifier diode. However, at the turning off of the first transistor, a surge voltage due to an inductance component such as a wire is generated at the second node through the additional diode. After this, for example, when the supply of the rectified current to the switch circuit is stopped, for example, by the turning on of a switching element connected between the third node and the ground, a potential difference is generated between the third node and each of the first and second nodes. However, the surge voltage at the second node causes the second transistor to have a comparatively low capacitance between the conductive electrodes. This results in the suppression of an electric current associated with charge and discharge of the capacitance between the conductive electrodes of the second transistor, thus reducing a loss of a circuit including the rectifier.

Alternatively, for example, the rectifier may further include a voltage application circuit (50) that applies a predetermined voltage (Vc) between the first and second nodes after the turning off of the first and second transistors and before the stoppage of the supply of the rectified current to the switch circuit.

An example of a circuit that embodies this technology is described in the fourth embodiment. When the supply of the rectified current to the switch circuit is stopped, for example, by the turning on of a switching element connected between the third node and the ground, a potential difference is generated between the third node and each of the first and second nodes. However, prior application of the predetermined voltage allows the second transistor to have a comparatively low capacitance between the conductive electrodes. This results in the suppression of an electric current associated with charge and discharge of the capacitance between the conductive electrodes of the second transistor, thus reducing a loss of a circuit including the rectifier.

Further, specifically, for example, a breakdown voltage between the first and second conductive electrodes of the first transistor may be lower than a breakdown voltage between the first and second conductive electrodes of the second transistor.

This allows the first transistor to be lower in conduction resistance and smaller in chip area than the second transistor.

### REFERENCE SIGNS LIST

10, 10A[i], 10B[i], 10C[i] Switch circuit
11 Low-breakdown voltage transistor
12, 14 Built-in diode
13 High-breakdown voltage transistor
15 Diode (FRD)
21 Coil
22 Transistor (low-side transistor)
50, 50A[i], 50B[i], 50C[i] Charging circuit
51 Voltage source

1. A rectifier comprising:
a switch circuit having first and second transistors, a rectifier diode, a first node, a second node, and a third node, the first and second transistors each having first and second conductive electrodes and a control electrode for bringing the first and second conductive electrodes into or out of conduction with each other, the rectifier diode having a cathode and an anode, the first conductive electrode of the first transistor and the cathode of the rectifier diode being connected to the first node, the second conductive electrodes of the first and second transistors being connected to the second node, the first conductive electrode of the second transistor and the anode of the rectifier diode being connected to the third node;
a connecting circuit that intermittently supplies a rectified current to the switch circuit in a forward direction of the rectifier diode; and
a control circuit that turns the first and second transistors on and off, respectively, when the rectified current starts to flow through the rectifier diode.

2. The rectifier according to claim 1, wherein the control circuit turns off the first and second transistors when the supply of the rectified current to the switch circuit stops.

3. The rectifier according to claim 2, wherein the first and second transistors are FETs, and
after the rectified current has started to flow through the rectifier diode, the control circuit passes the rectified current through the first and second transistors by turning on the first and second transistors in a part of a period up to the stoppage of the supply of the rectified current to the switch circuit.

4. The rectifier according to claim 3, wherein the second transistor has added thereto an additional diode whose forward direction is a direction from the third node toward the second node, and
after having turned on the first and second transistors in the part of the period, the control circuit turns off the second transistor earlier than the first transistor in a process of turning off the first and second transistors.

5. The rectifier according to claim 2, further comprising a voltage application circuit that applies a predetermined voltage between the first and second nodes after the turning off of the first and second transistors and before the stoppage of the supply of the rectified current to the switch circuit.

6. The rectifier according to claim 1, wherein a breakdown voltage between the first and second conductive electrodes of the first transistor is lower than a breakdown voltage between the first and second conductive electrodes of the second transistor.
